(19) United States
(12) Patent Application Publication
(10) Pub. No.: US 2019/0124401 A1
(43) Pub. Date: Apr. 25, 2019

(54) SYSTEMS AND METHODS FOR MULTIMEDIA TOURS

(71) Applicant: Antenna Audio, Inc., Norwalk, CT (US)

(72) Inventor: Sean Lentner, Wilton, CT (US)

(21) Appl. No.: 16/168,862

(22) Filed: Oct. 24, 2018

Related U.S. Application Data
(63) Continuation of application No. PCT/US18/56965, filed on Oct. 23, 2018.
(60) Provisional application No. 62/576,216, filed on Oct. 24, 2017.

(51) Int. Cl. H04N 21/485; H04W 60/04; H04N 21/214; H04W 4/021; H04N 21/222; H04N 21/6332; H02J 7/00

(52) U.S. Cl. CPC H04N 21/485; H04W 60/04; H04N 21/2143; H02J 7/0027; H04N 21/2223; H04N 21/6332; H04W 4/021

(57) ABSTRACT

Systems, apparatus, methods, and articles of manufacture for multimedia tours such as enhanced management of proprietary mobile electronic devices, enhanced group tour management, and operationally feasible user-owned device content delivery, are provided.

### CROSS-REFERENCE TO RELATED APPLICATIONS

The present application claims benefit and priority to, and is a continuation of International Patent Application No. PCT/US18/56965 filed on Oct. 23, 2018 and titled “SYSTEMS AND METHODS FOR MULTIMEDIA TOURS”, which itself claims benefit and priority to and is a non-provisional of, U.S. Provisional Patent Application No. 62/576216 titled “SYSTEMS AND METHODS FOR MULTIMEDIA TOURS” and filed on Oct. 24, 2017, the entirety of such previous applications being hereby incorporated by reference herein.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Electronically-enhanced tours of historic, cultural, and other tourist sites are typically implemented via proprietary mobile electronic device units that are pre-loaded with audio and/or other media, often in a particular language. The maintenance and loss rates for these devices are high, however, which adds significant hardware repair and/or replacement costs, causes lost time and effort required to maintain existing devices and/or setup new devices, and may lead to increased down-time for tour operations (e.g., insufficient quantities of devices for tour participants).

Proprietary device maintenance can often be particularly time consuming and costly even in the absence of loss, theft, or repair issues. Mobile electronic tour devices require repetitive charge cycles to maintain power availability and may need tour data and/or firmware updates at various operational intervals. Coordinating device charging and update schedules and statuses can be time consuming and expensive, especially in the case that a particular tour location maintains large numbers of devices.

Group tours led by a guide may also be problematic in many situations. Typically, for example, proprietary devices desired to be utilized as part of a group tour must be pre-programmed or allocated to a specific group. Group members that trail behind, wander away, or otherwise exceed the broadcast distance from a master tour guide device may be cut off from the guided tour, become lost, or miss important information.

### BRIEF DESCRIPTION OF THE DRAWINGS

The figures depict embodiments for purposes of illustration only. One skilled in the art will readily recognize from the following description that alternative embodiments of the systems and methods illustrated herein may be employed without departing from the principles described herein, wherein:

FIG. 1A and FIG. 1B are perspective and block diagrams of prior art device-guided tour systems;

FIG. 2 is block diagram of a system according to some embodiments;

FIG. 3 is block diagram of a system according to some embodiments;

FIG. 4 is block diagram of a system according to some embodiments;

FIG. 5A, FIG. 5B, FIG. 5C, FIG. 5D, FIG. 5E, FIG. 5F, FIG. 5G, FIG. 5H, and FIG. 5I are diagrams of a system providing example interfaces according to some embodiments;

FIG. 6 is a flow diagram of a method according to some embodiments;

FIG. 7 is a flow diagram of a systemic method according to some embodiments;

FIG. 8 is block diagram of a system according to some embodiments;

FIG. 9 is a flow diagram of a method according to some embodiments;

FIG. 10 is a flow diagram of a systemic method according to some embodiments;

FIG. 11 is block diagram of a system according to some embodiments;

FIG. 12 is a flow diagram of a method according to some embodiments;

FIG. 13 is a block diagram of an apparatus according to some embodiments; and

FIG. 14A, FIG. 14B, FIG. 14C, FIG. 14D, and FIG. 14E are perspective diagrams of exemplary data storage devices according to some embodiments.

### DETAILED DESCRIPTION

### I. Introduction

At least because of the many issues with typically electronically-enhanced tour services (and/or other mobile device media distribution services), user engagement with such services has suffered. Tour locations and/or operational organizations (e.g., museums and non-profit historical societies) have spent large sums of money in acquiring and maintaining proprietary mobile electronic tour devices or in attempting to develop and provide mobile device applications for download and use on user-owned devices. Proprietary devices suffer from several deficiencies however (high loss rates, expensive maintenance), and user device downloads of mobile applications have proven to be frustrating for users. User engagement with downloadable applications, for example, is generally inversely proportional to the amount of time needed to activate a downloadable media experience. Typical app store searching, purchasing, downloading, and initialization process may require eight (8) separate steps, many of which may require user input, and may often take upwards of thirty-eight (38) seconds, for example. It is believed that every step and/or user input requirement (and/or respective five (5) to ten (10) seconds) may enhance user attrition rates by approximately twenty percent (20%). Thus, any decrease in the number of required download steps, amount of required user input, and/or required time, may substantially increase user engagement with downloadable applications (e.g., to a user's personal mobile electronic device). Both proprietary and personal-use devices, when utilized in group tour situations, are also necessarily limited in capabilities—proprietary devices because they must be inexpensive and simple devices to be commercially viable in a group tour environment, and personal devices because the ability to distribute customized software to user devices is limited by system and operational constraints (e.g., ability to maintain user engagement).

In accordance with embodiments herein, these and other deficiencies of previous efforts are remedied by providing systems, apparatus, methods, and articles of manufacture for multimedia tours as described herein. In some embodiments, for example, tours (and/or other mobile device media distribution endeavors) utilizing proprietary devices (e.g., devices not owned by end-users) are enhanced and/or made more profitable by (i) providing for automatic charge and update (or upgrade) management and/or (ii) providing simplified and/or enhanced group tour content distribution. According to some embodiments, tours (and/or other mobile device media distribution endeavors) may be enhanced by leveraging user-owned (and/or operated) devices as content delivery mechanisms. In some embodiments, for example, Digital Distribution Point (DDP) devices may be employed to disseminate desired content in a manner that is quick, simplified, and/or does not overtax network bandwidth. Group tours utilizing either personal or proprietary tour devices may, according to some embodiments, be enhanced by providing for mesh-network parent-child and child-child device communications and discrete geo-location functionality.

### II. Typical Device-Guided Tour Systems

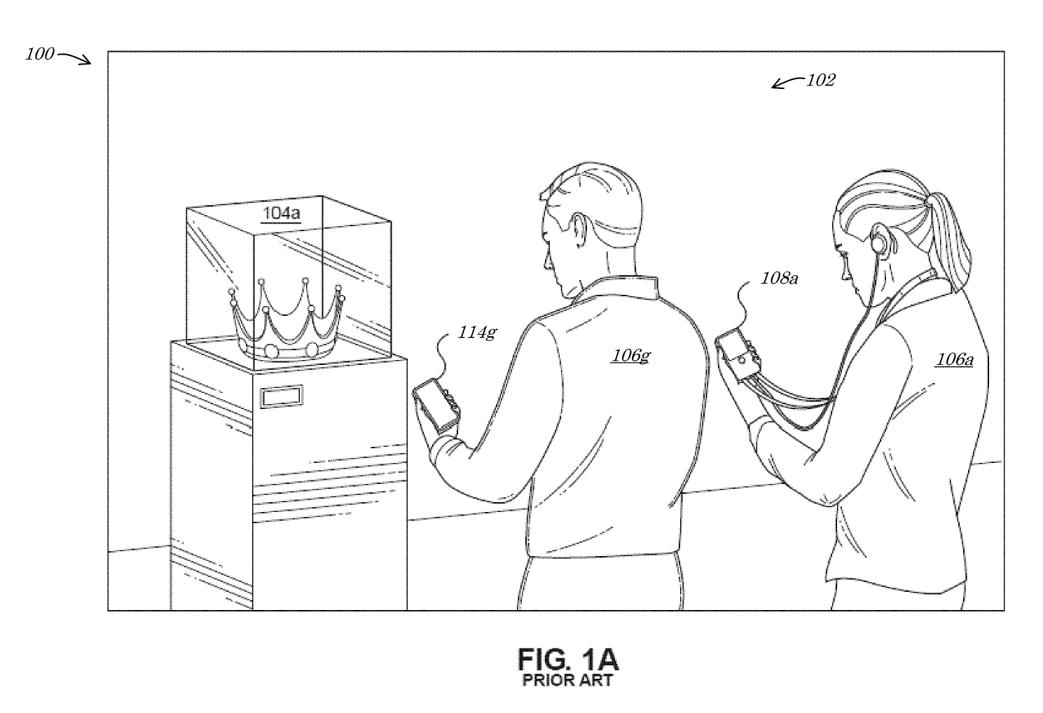

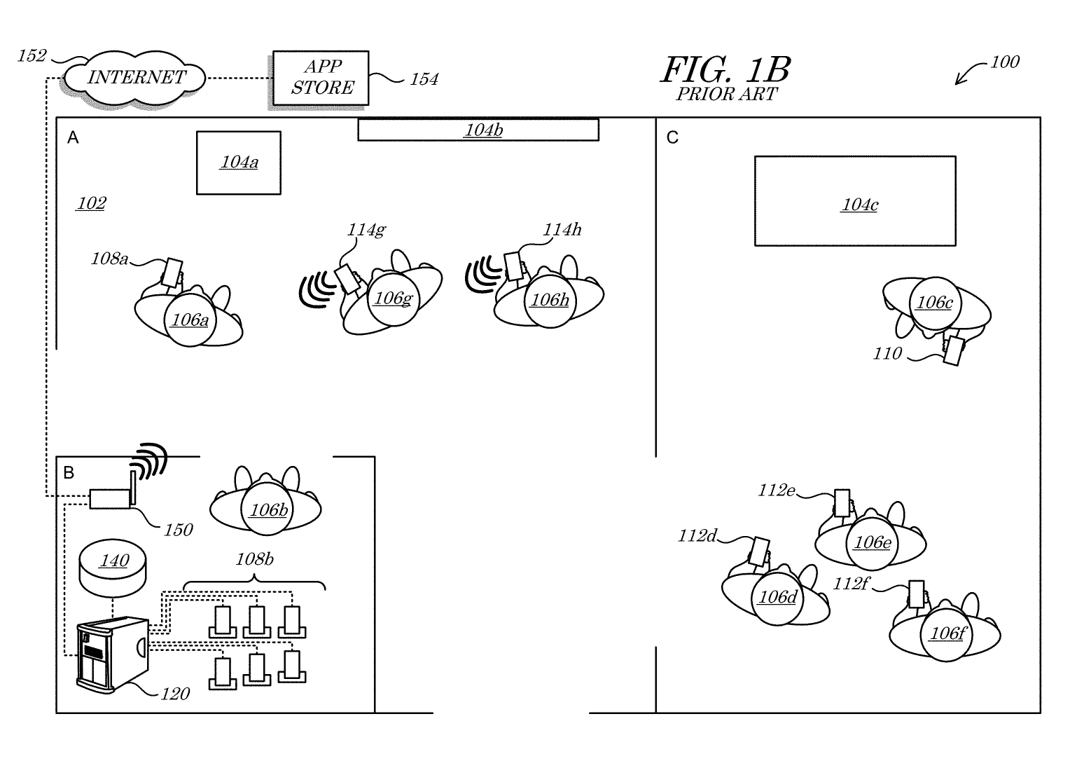

Referring first to FIG. 1A and FIG. 1B, perspective and block diagrams of a prior art device-guided tour system 100 are shown. The tour system 100 may typically comprise, for example, a tour location 102 such as a museum or historic site that includes a plurality of objects of interest 104a-c (e.g., a first object 104a such as a crown and/or jewels, a second object 104b such as painting, and/or a third object 104c such as a statue or sculpture). At the tour location 102, a plurality of people or tourists 106a-h may be present to view, observe, and/or learn about the various objects of interest 104a-c. While the people/tourists 106a-h may, of course, tour the location 102 at their leisure and/or design or may sign up to take a tour led by a human guide, modern the typical modern tour system 100 permits the people/tourists 106a-h to utilized proprietary mobile devices 108a-b via which they may receive audio and/or view images and/or text, to enhance their tour experience. A first tourist 106a in a first room “A” of the location 102 may utilize a first proprietary mobile device 108a, for example, that provides information regarding the first object of interest 104a that is proximate to the first tourist 106a.

One or more second proprietary devices 108b may be available for other people/tourists 106a-h such as by being stored in a second room “B” at the location 102 (as shown in FIG. 1B). The one or more second proprietary devices 108b may be stored in bins or holders, and/or may be plugged-in to electrical outlets for charging or attached to charging units (not separately labeled in FIG. 1A and FIG. 1B), for example, and/or may be distributed by an attendant 106b. While the attendant 106b may, at certain locations 102, exchange a second proprietary device 108b for an identification card (e.g., a driver's license) or may otherwise require the second proprietary device 108b to be signed-out, many locations 102 attract a sufficient volume of people/tourists 106a-h that such check-out, exchange, or reservation practices are not practicable—e.g., they create long lines that are disadvantageous to the location 102 in general and also provide a disincentive to usage of the proprietary devices 108a-b.

In some cases, the location 102 may allow, sponsor, or conduct guided or group tours that are supplemented with audio (e.g., in a specific language and/or translated) and/or images. A tour guide 106c located in a third room “C” at the location 102 may, for example, carry a tour guide or parent device 110 that captures the tour guide's voice narrative regarding the third object of interest 104c and transmits it to a plurality of child devices 112d-f carried by members (e.g., group members) of the tour 106d-f. In many cases, the group members 106d-f may utilize earphones (not separately labeled in FIG. 1A or FIG. 1B) to better hear the narrative received from the parent device 110 of the tour guide 106c. To properly received the tour narrative, the child devices 112d-f must all be tuned to the same frequency, must be preloaded with specific content for the specific tour (e.g., many locations 102 offer various tours), and/or be manually paired (typically before initiation of the tour) with the parent device 110.

Some locations 102 have attempted to transition from the use of proprietary devices 108a-b, 110, 112d-f by allowing some tourists 106g-h to utilize their own devices 114g-h to access and/or utilize audio and/or image content. Seventh and eighth tourists 106g-h may utilize their own devices 114g-h to receive and/or access information descriptive of the second object of interest 104b in the first room “A”, for example. Usage of personal devices 114g-h, however, typically requires the users/tourists 106g-h to download a proprietary application (not separately depicted) either before arriving at the location 102 or while at the location 102, utilizing wireless network resources available at the location 102. A server 120 at the location 102 may, for example, manage and/or provide access to tour data (not separately depicted) stored in a database 140. Proprietary devices 108a-b, 110, 112d-f may be interfaced with the server 120 directly, such as after-hours, to download tour content onto each proprietary device. As tour content may often be provided in various languages and/or for various differing tours, certain proprietary devices 108a-b, 110, 112d-f are typically loaded with certain language versions of the tour content and/or with certain particular tour content.

Personal devices 114g-h may retrieve the tour content from the database 140 via the server 120 and/or a wireless router 150. In many typical cases, such as where only authorized applications are permitted on a user's personal device 114g-h, the tour content must be accessed by first downloading a proprietary mobile device application from utilizing the Internet 152 to access a device-specific app store 154. As described herein, each step required for the tourists 106g-h to obtain access to the tour content causes a dramatic drop in user retention. In other words, requiring the seventh tourist 106g to log onto the router 150, access the app store 154, locate the proper application for the location 102, and wait to download the application, will likely cause the seventh tourist 106g to abandon the attempt to take advantage of the device-guided tour options at the location 102. This issue is compounded by the fact that the amount of network bandwidth required by the router 150 to manage significant numbers of tourists 106g-h with their own devices 114g-h is often not economically practicable for the location 102. Many locations 102 are remote and accordingly have limited bandwidth opportunities, for example, and/or cellular reception that the tourists 106g-h may otherwise take advantage of to supplement the local wireless network is often not reliable or even available at remote tourist locations.

### III. Improved Device-Guided Tour Systems

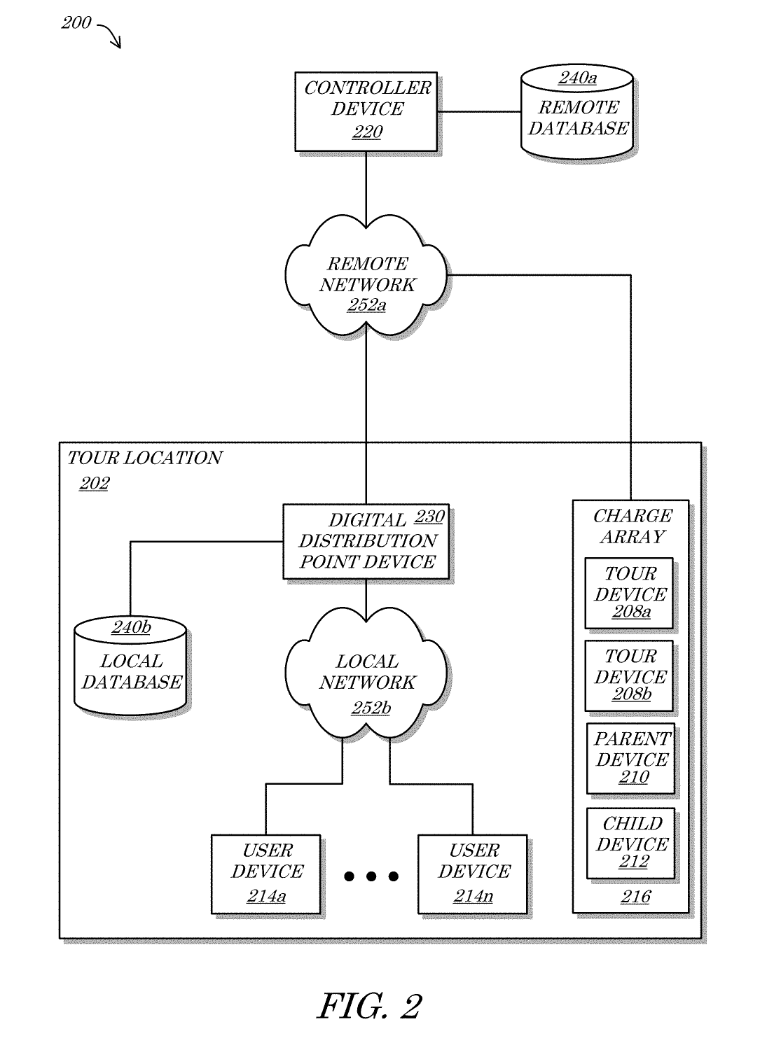

Turning to FIG. 2, a block diagram of a system 200 according to some embodiments is shown. In some embodiments, the system 200 may comprise a tour location 202 that offers proprietary tour devices 208a-b and/or group tour devices such as a parent device 210 and a child device 212a, via which multimedia content descriptive of the tour location 202 may be obtained. According to some embodiments, the tour location 202 may also or alternatively allow, permit, facilitate, and/or manage utilization of personal devices 214a-n via which the multimedia content may be obtained. In some embodiments, the proprietary tour devices 208a-b, parent device 210, and/or child device 212a may be coupled to and/or form a charge array 216. As described in greater detail hereinafter, for example, the charge array 216 may comprise one or more charging units comprising a plurality of interconnected charging bays (not separately depicted in FIG. 2).

In some embodiments, tour content may be provided to any or all of the proprietary tour devices 208a-b, the parent device 210, the child device 212a, and/or the personal devices 214a-n via a controller device 220 and/or a Digital Distribution Point (DDP) device 230. Data may be loaded onto the proprietary tour devices 208a-b, parent device 210, and/or child device 212a from a first or remote database 240a via the controller device 220, for example, and/or the controller device 220 may cause a downloading or populating of data from the remote database 240a into a second or local database 240b (e.g., via the DDP device 230). As depicted in FIG. 2, any given tour location 202 may utilize one or more of two (2) primary multimedia distribution methodologies: (i) issuing proprietary self-guided tour devices 208a-b, parent devices 210 and/or child devices 212a for group tours at the tour location 202, to visitors (the visitors not being shown in FIG. 2), and (ii) allowing visitors to utilize their own personal devices 214a-n to conduct self-guided tours at the tour location 202.

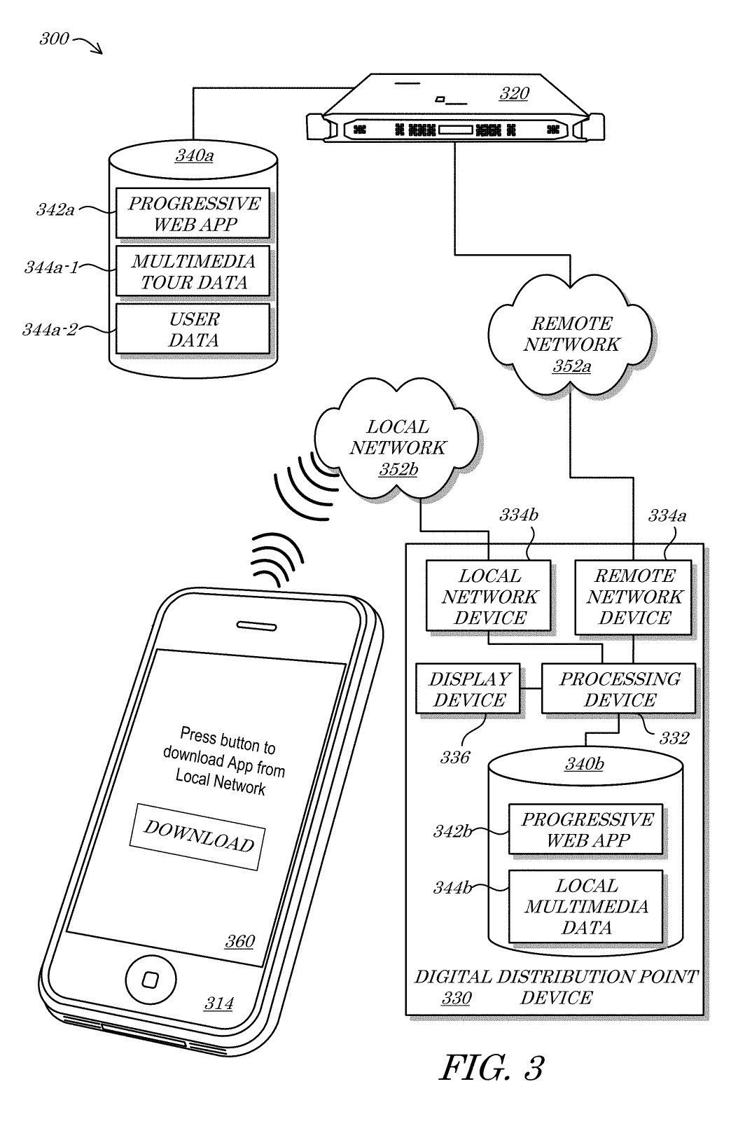

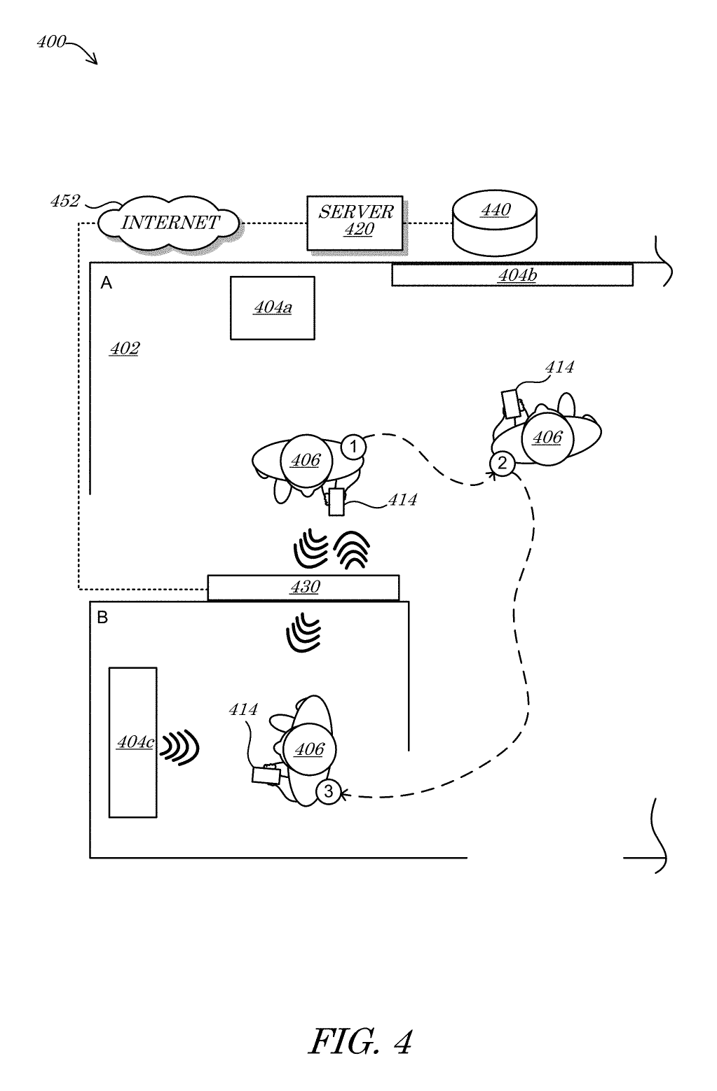

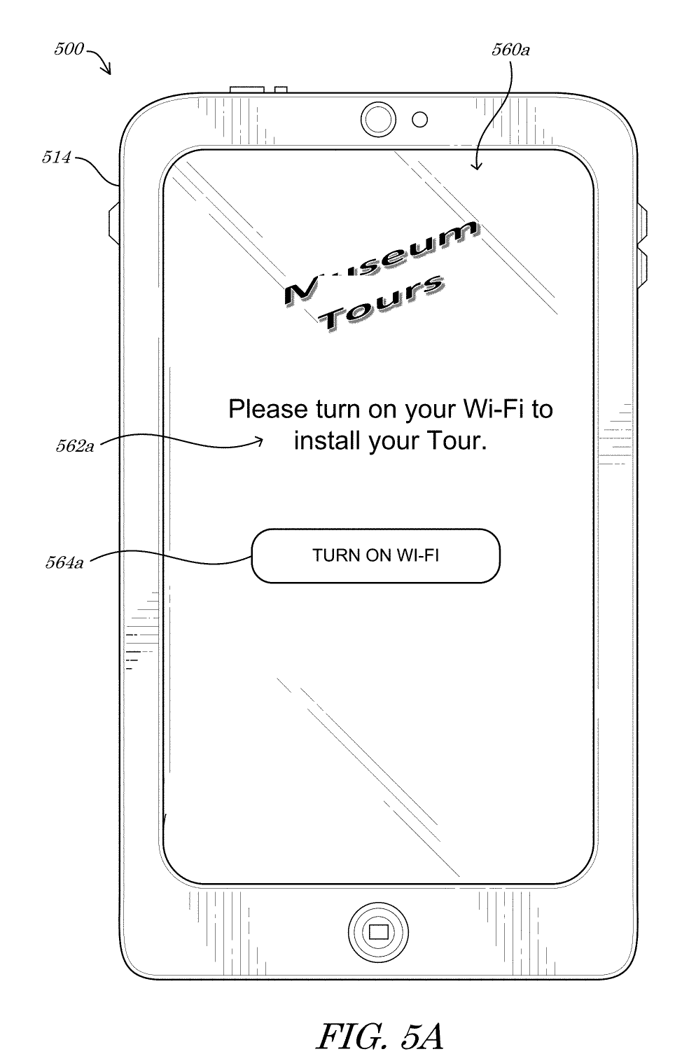

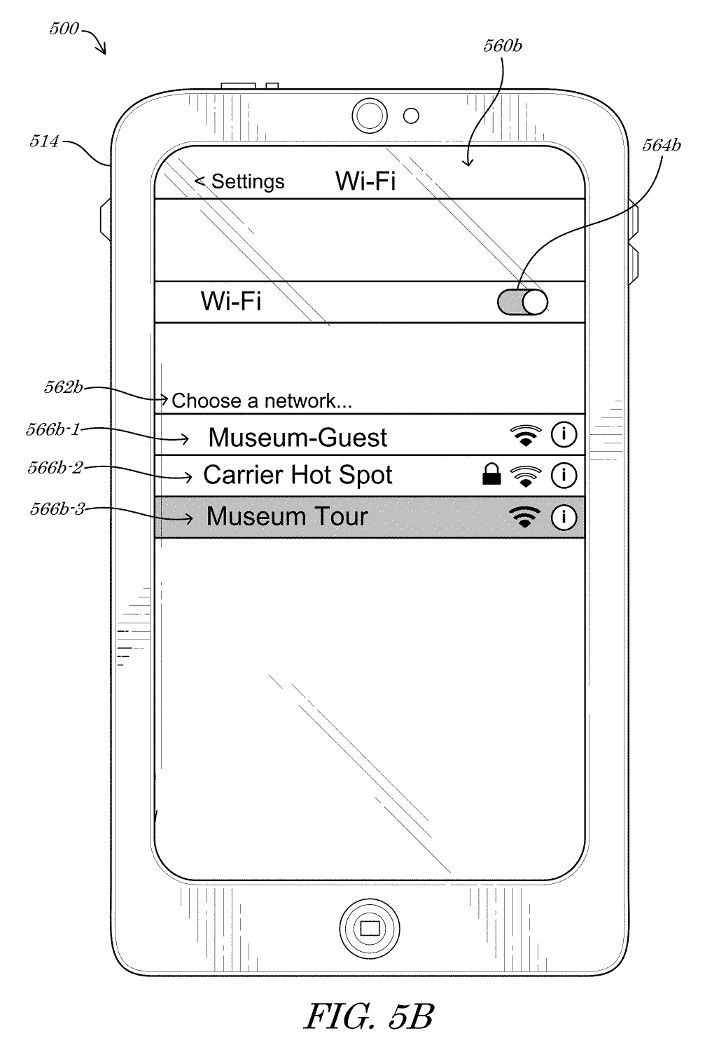

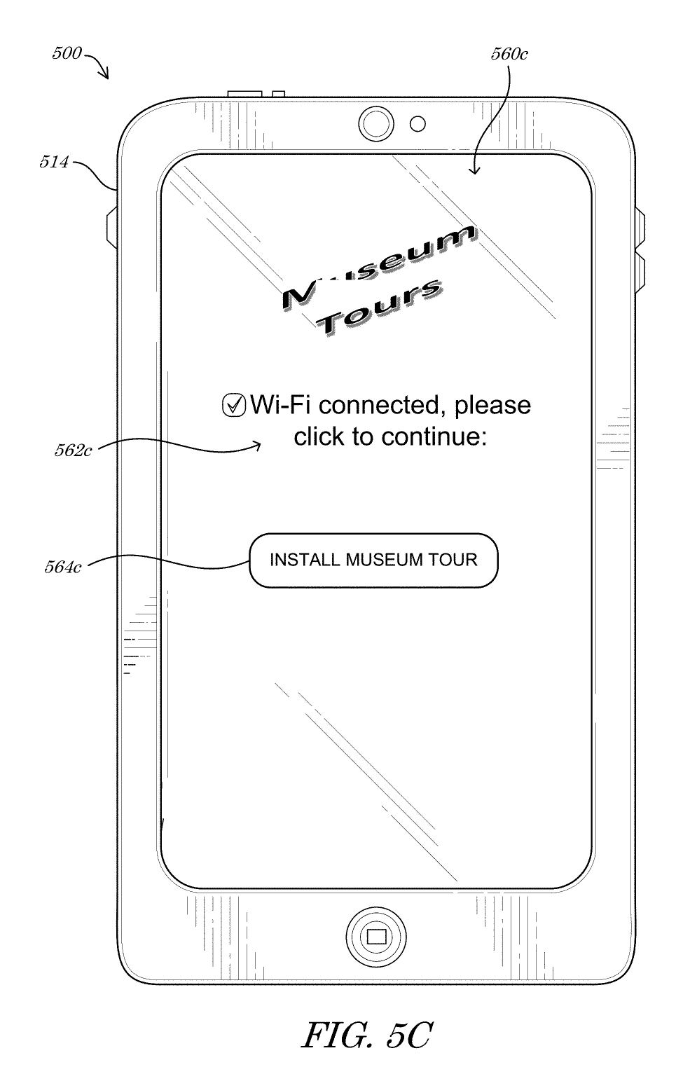

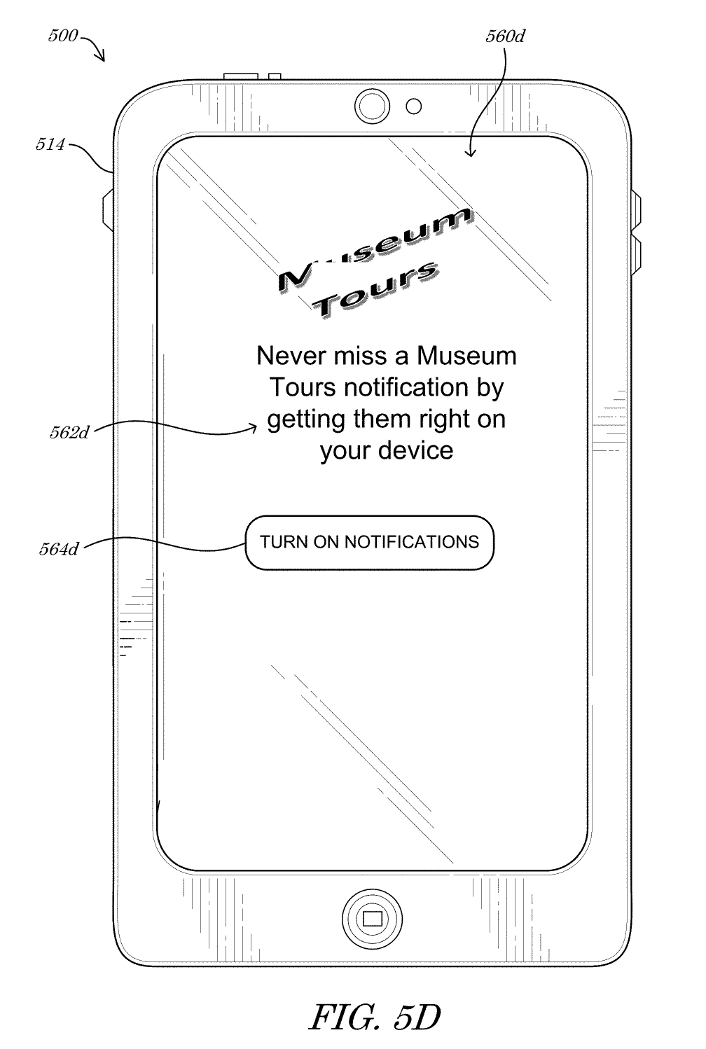

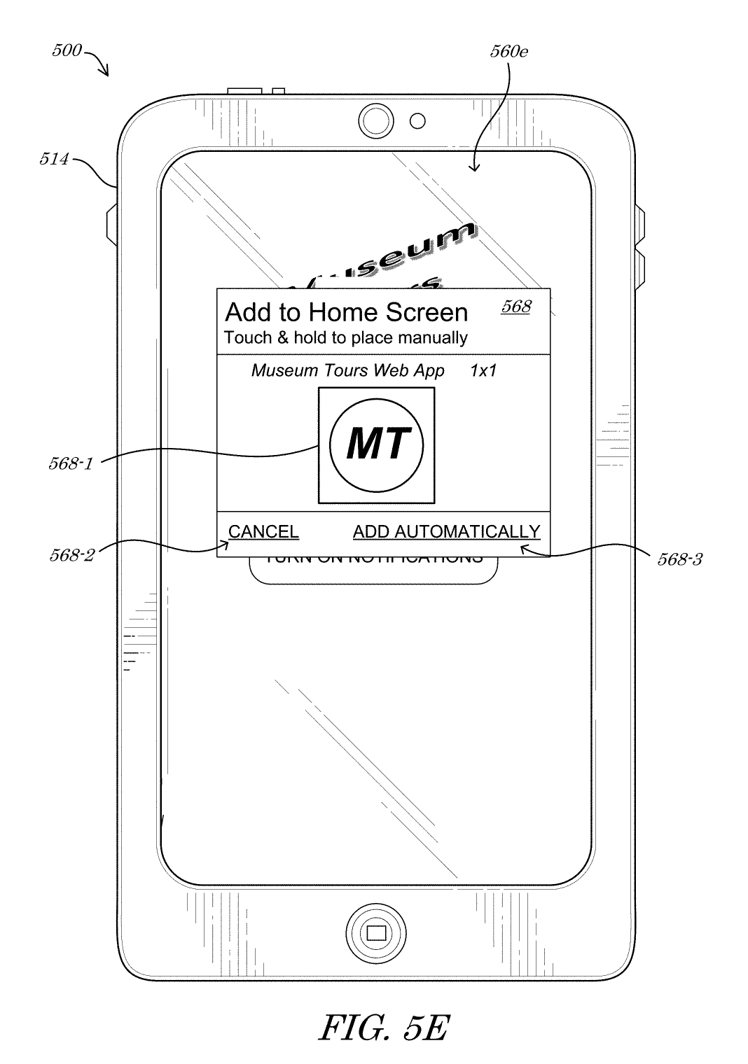

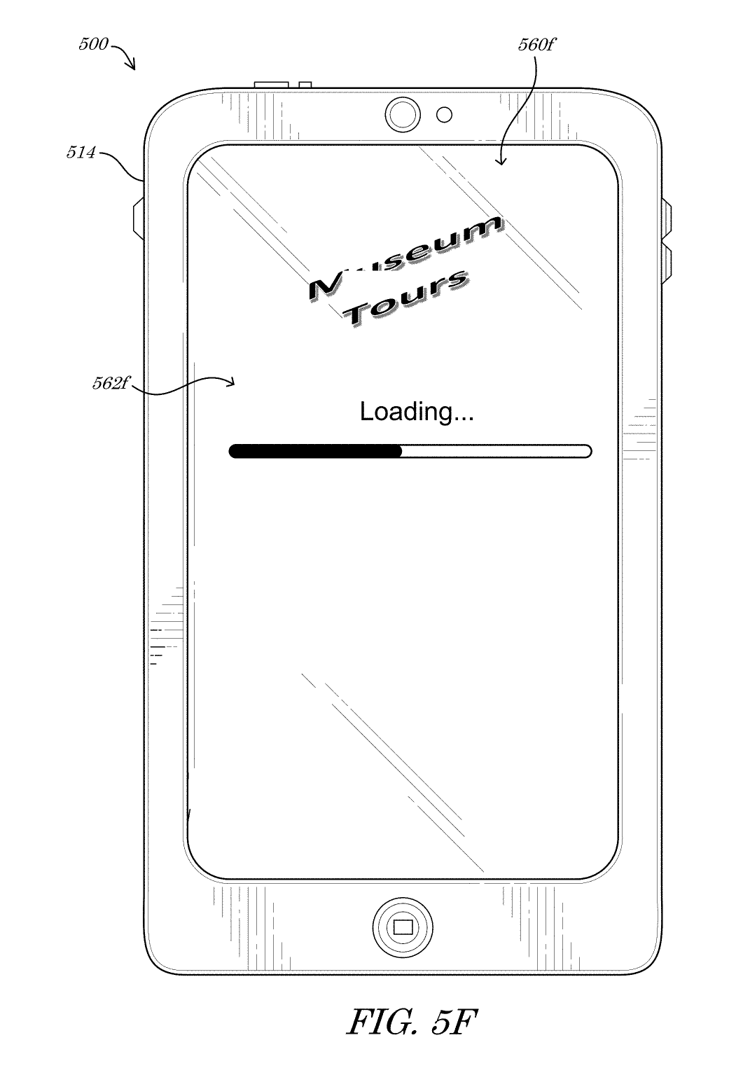

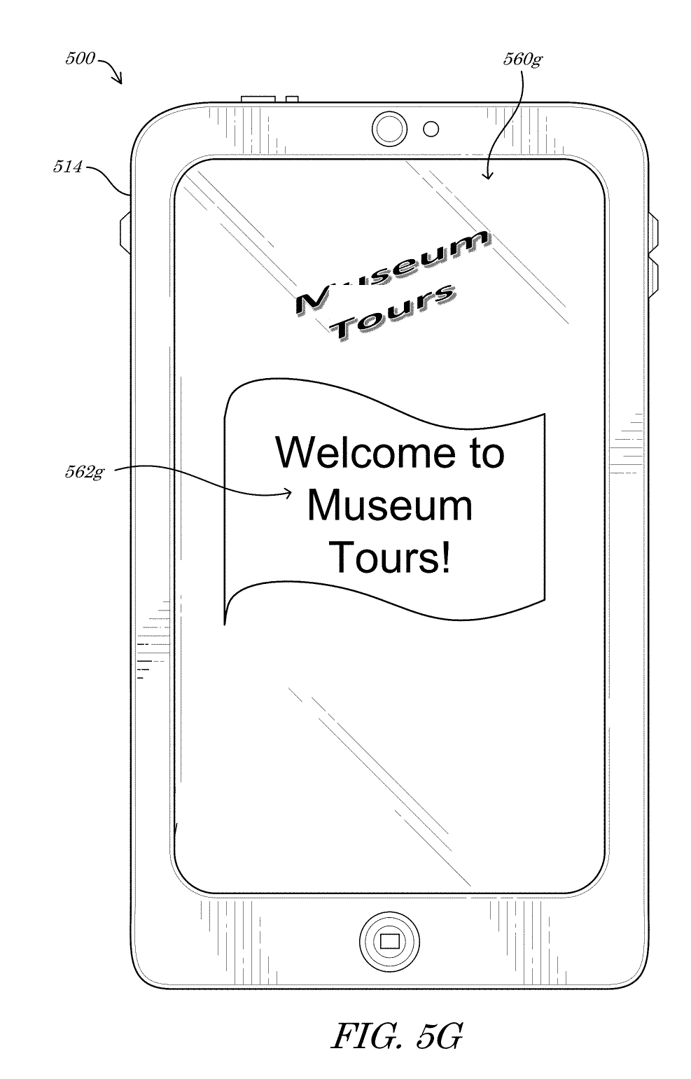

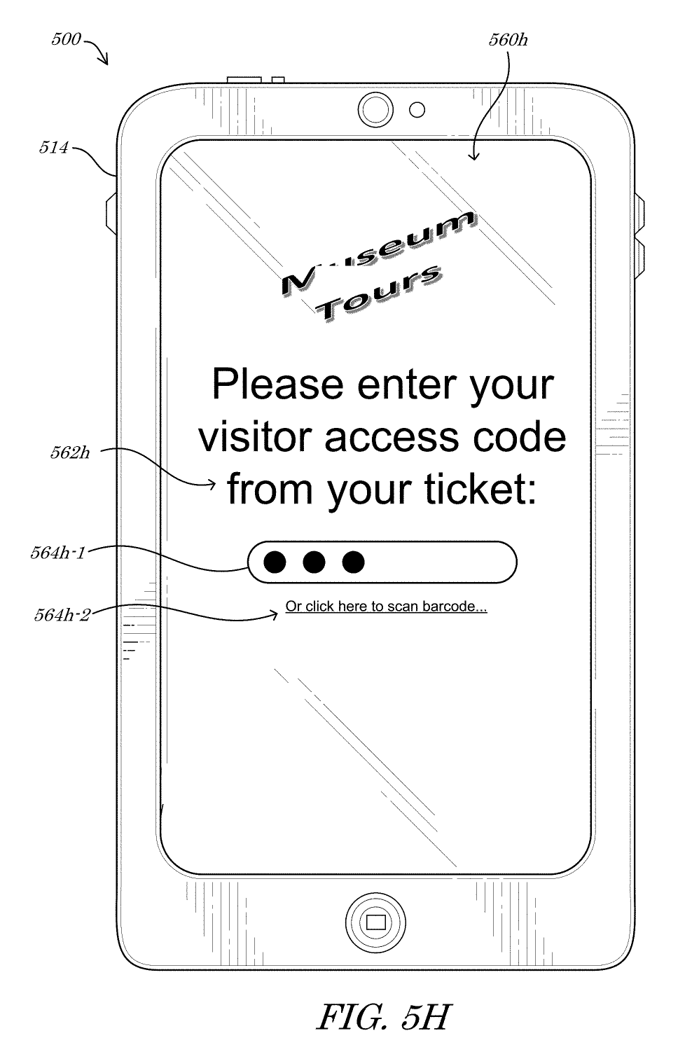

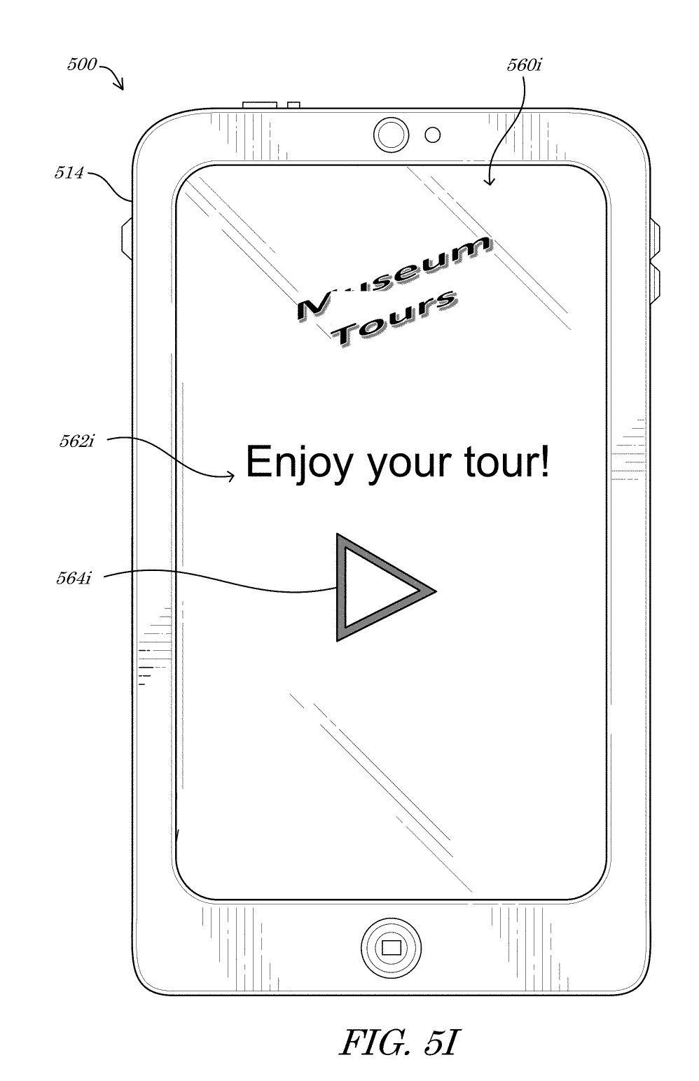

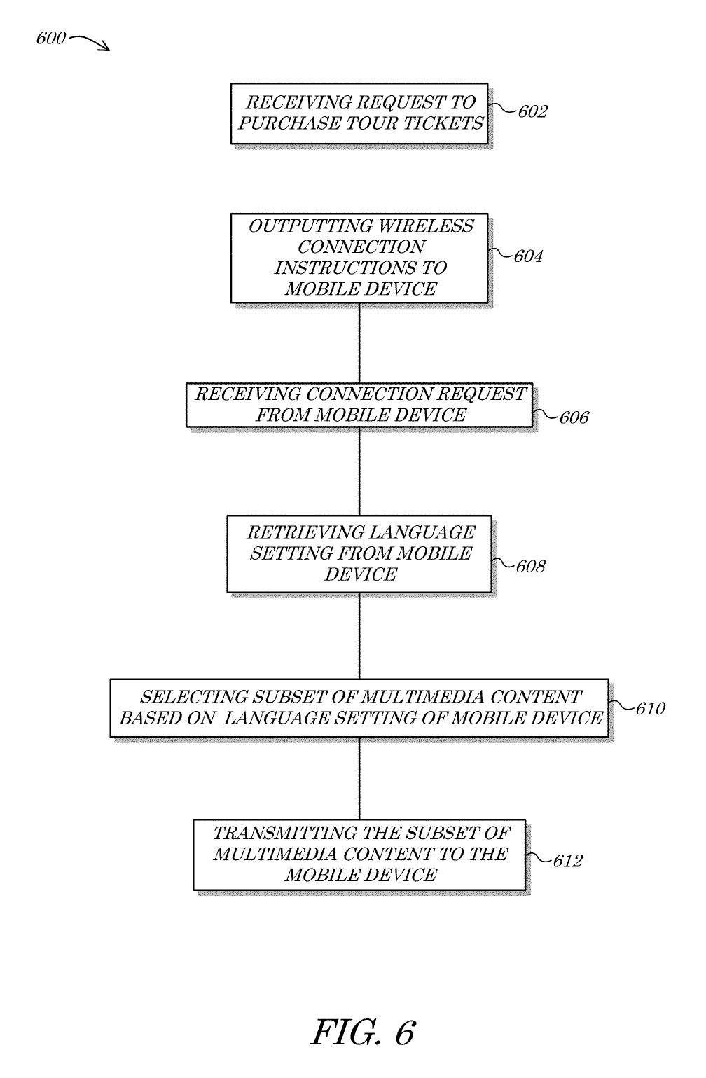

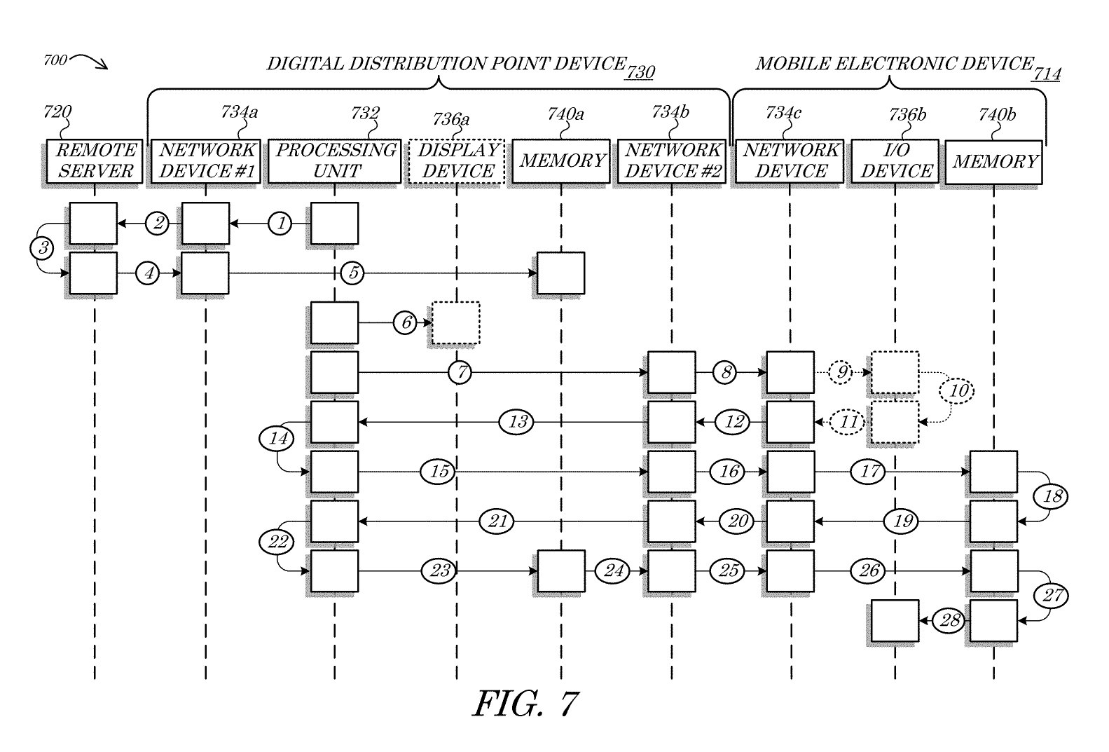

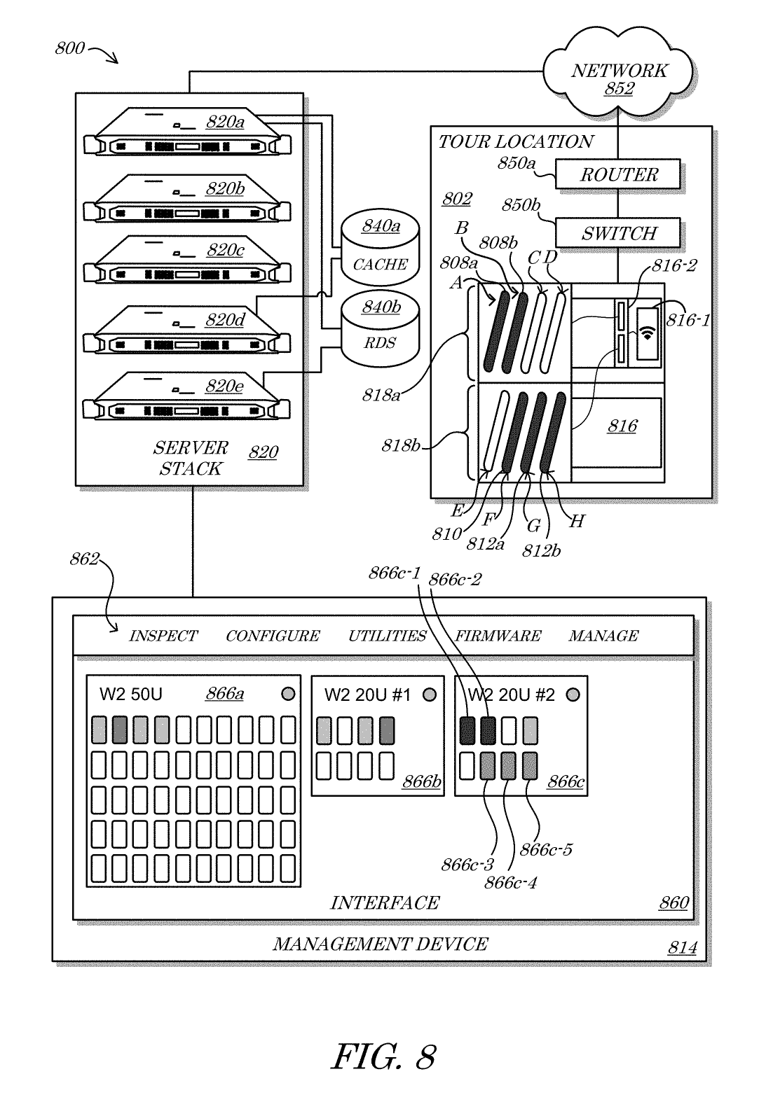

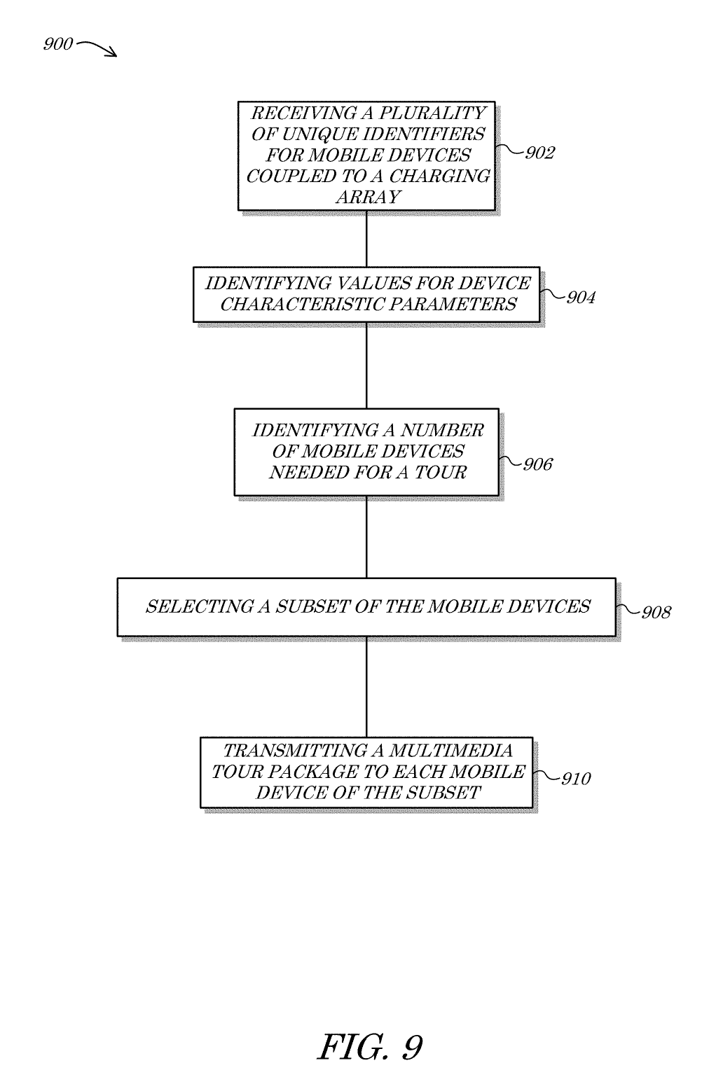

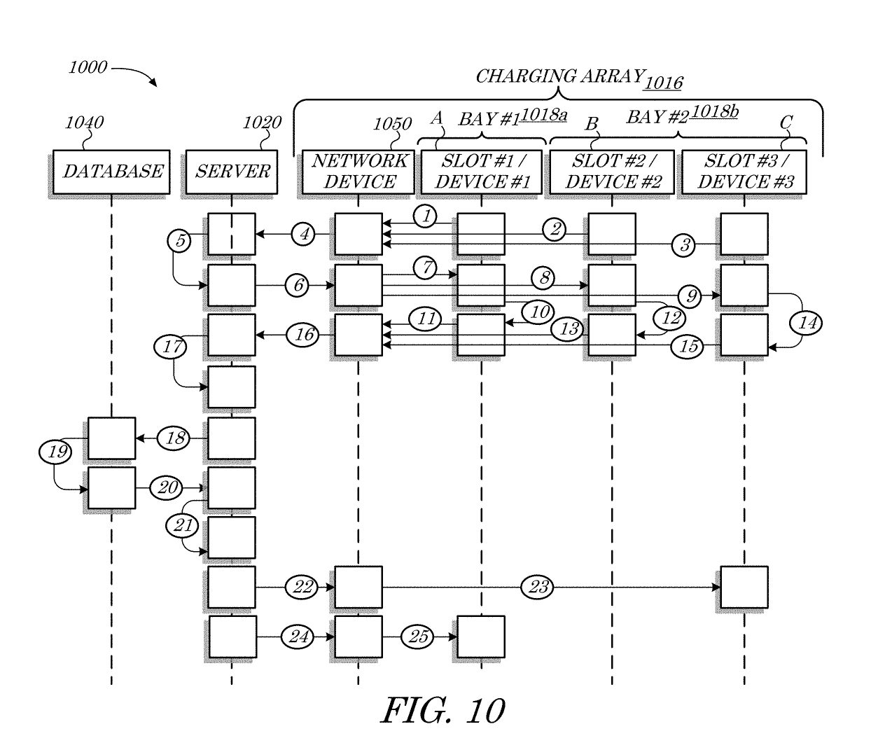

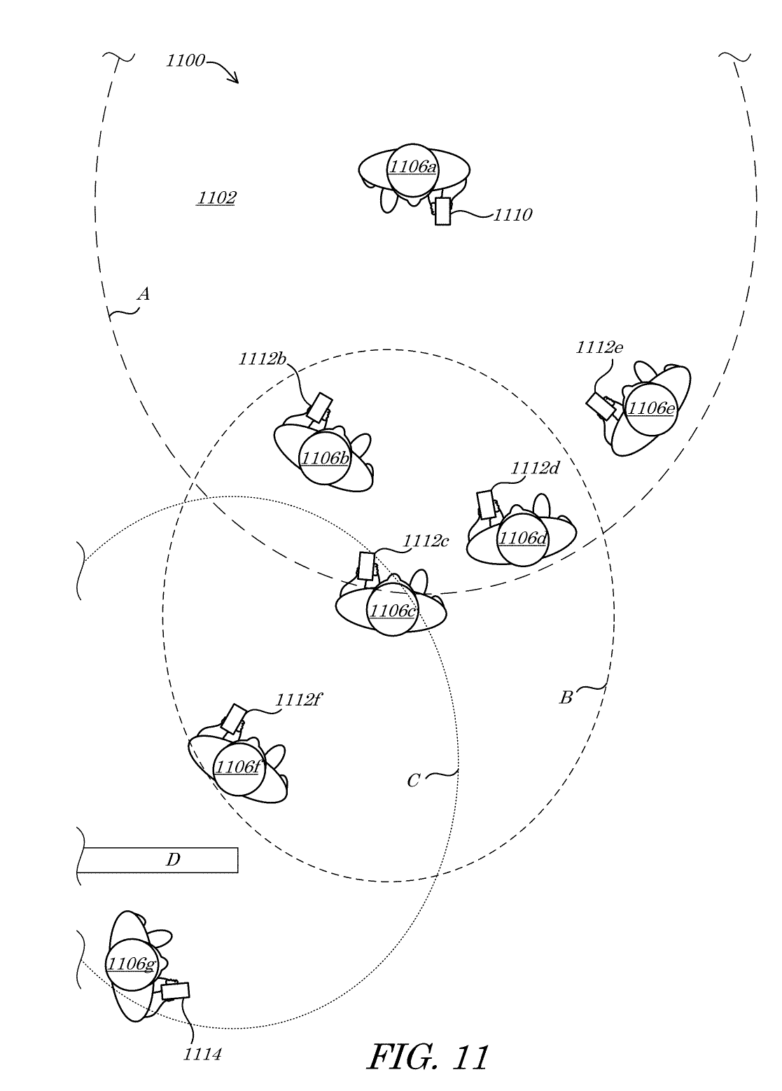

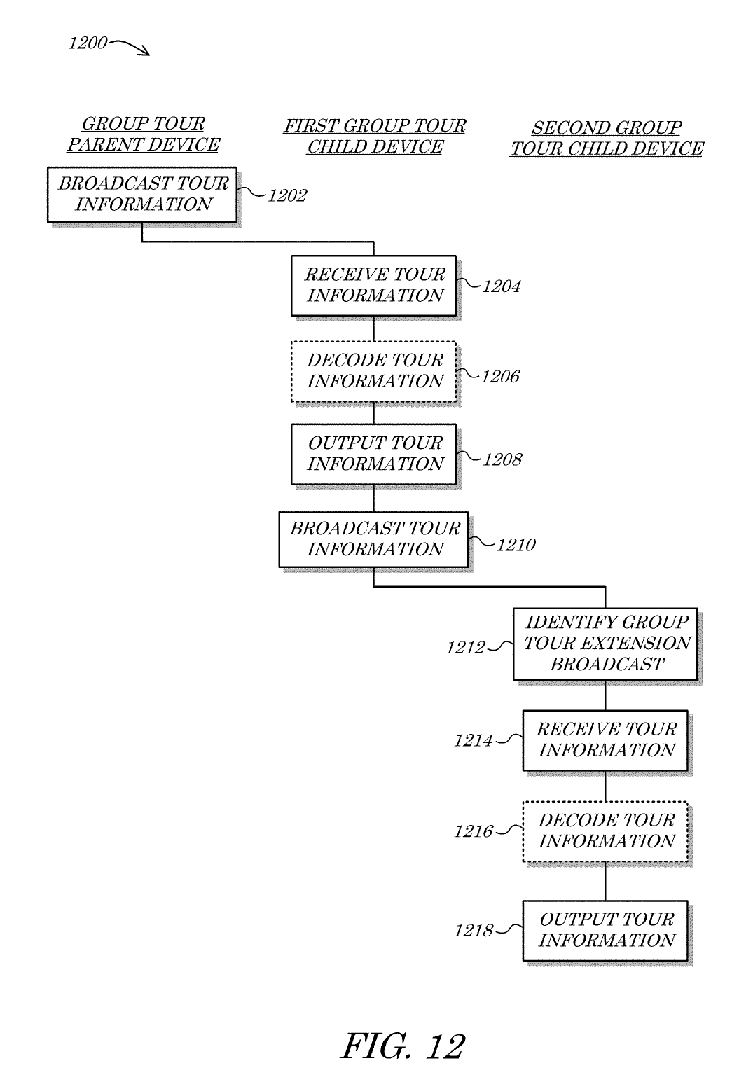

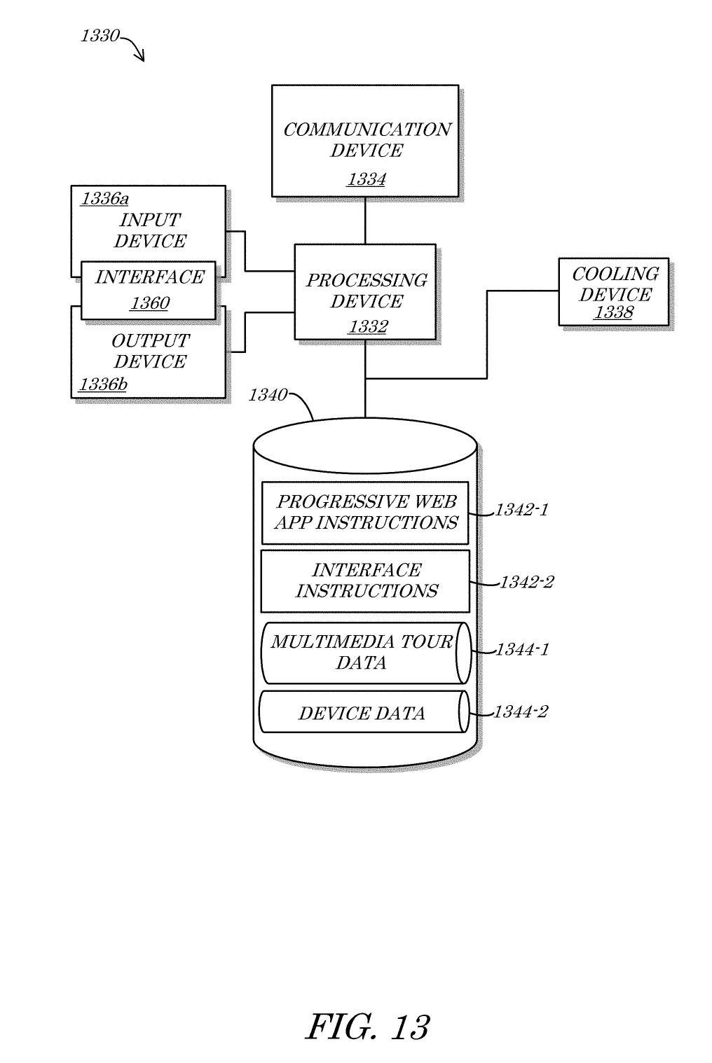

In the former case, utilization of various proprietary devices 208a-b, 210, 212a may be effectuated by downloading tour content from the remote database 240a via a first or remote network 252a (e.g., via the controller device 220) and handing out the various proprietary devices 208a-b, 210, 212a to visitors. In accordance with embodiments for enhanced multimedia tour systems as described herein, management of the charge state, firmware version, content, and/or functionality of the various proprietary devices 208a-b, 210, 212a may be managed remotely by the controller device 220. In the latter case, the various personal devices 214a-n may access tour content from the local database 240b by accessing the DDP device 230 through a second or local network 252b (e.g., a short-range communications network such as may be operated in accordance with Near Field Communication (NFC) or Bluetooth® standards). In such a manner, for example, broadband Internet usage via the remote network 252a may not be overtaxed by request from personal devices 214a-n, which may number in the hundreds or even thousands for large and/or popular locations 202. Various improvements involving the distribution of multimedia tour content through the use of personal devices 214a-n are described in more detail herein with respect to FIG. 3, FIG. 4, FIG. 5A, FIG. 5B, FIG. 5C, FIG. 5D, FIG. 5E, FIG. 5F, FIG. 5G, FIG. 5H, FIG. 5I, FIG. 6, and FIG. 7. Embodiments involving improvements for the distribution of multimedia tour content through the use of various proprietary devices 208a-b, 210, 212a are described in more detail herein with respect to FIG. 8, FIG. 9, FIG. 10, FIG. 11, and FIG. 12.

In some embodiments, the proprietary devices 208a-b, 210, 212a may comprise any types or configurations of computing, mobile electronic, network, user, and/or communication devices that are or become known or practicable. According to some embodiments, the proprietary devices 208a-b, 210, 212a may not be available for sale to the general public (e.g., may be “proprietary”) and/or may be owned by an entity that owns and/or manages the tour location 202 (e.g., not owned by the visitors). The proprietary devices 208a-b, 210, 212a may, for example, comprise one or more Antenna™ XP3 multimedia players or Antenna™ M3™ multimedia devices operating running the Android® operating system from Google®, Inc. of Mountain View, Calif., each available from Antenna International of London, UK. In some embodiments, the proprietary devices 208a-b, 210, 212a may be specifically programmed to perform limited functions such as playing a multimedia tour or communicating with another proprietary device 208a-b, 210, 212a. The proprietary devices 208a-b, 210, 212a may, for example, not be equipped and/or configured to make cellular telephone calls or to access the Internet (e.g., the remote network 252a)—e.g., to make the proprietary devices 208a-b, 210, 212a less desirable for theft.

According to some embodiments, the personal devices 214a-n may comprise any types or configurations of computing, mobile electronic, network, user, and/or communication devices that are or become known or practicable. The personal devices 214a-n may, for example, comprise one or more tablet computers such as an iPad® manufactured by Apple®, Inc. of Cupertino, Calif., and/or cellular and/or wireless telephones such as an iPhone® (also manufactured by Apple®, Inc.) or an LG Optimus™ Zone™ 3 smart phone manufactured by LG® Electronics, Inc. of San Diego, Calif., and running the Android® operating system from Google®, Inc. of Mountain View, Calif. In some embodiments, the personal devices 214a-n may comprise devices owned and/or operated by one or more users such as tourists, tour members, group members, etc.

In some embodiments, the proprietary devices 208a-b, 210, 212a and/or the personal devices 214a-n may interface with one or more other proprietary devices 208a-b, 210, 212a and/or personal devices 214a-n (such communication not explicitly shown in FIG. 2) operated by other users, for example. In the case of a group tour, for example, the parent device 210 may comprise a group leader or tour guide device (e.g., a “parent” or “leader” device) which may be in direct communication with the child device 212 (e.g., a client, “child”, or “follower” device) operated by a tour participant. According to some embodiments described herein, a child device 212 may be in communication with the parent device 210 via one or more other child devices 212 (not separately depicted in FIG. 1). In such a manner, for example, child devices 212 may be strung or meshed together in an ad-hoc or dynamic network (not separately depicted din FIG. 2) to provide increased range and functionality to the parent device 210.

According to some embodiments, the controller device 220 may comprise an electronic and/or computerized controller device such as a computer server communicatively coupled to interface with the DDP device 230 and/or the proprietary devices 208a-b, 210, 212a (directly and/or indirectly—e.g., via the charge array 216). The controller device 220 may, for example, comprise one or more PowerEdge™ R830 rack servers manufactured by Dell®, Inc. of Round Rock, Tex. which may include one or more Twelve-Core Intel® Xeon® E5-4640 v4 electronic processing devices. In some embodiments, the controller device 220 may comprise a plurality of processing devices specially-programmed to execute and/or conduct processes as described herein. According to some embodiments, the controller device 220 may be located remote from one or more of the proprietary devices 208a-b, 210, 212a and/or the DDP device 230. The controller device 220 may also or alternatively comprise a plurality of electronic processing devices located at one or more various sites and/or locations (e.g., including the tour location 202).

According to some embodiments, the controller device 220 may store and/or execute specially programmed instructions to operate in accordance with embodiments described herein. The controller device 220 may, for example, execute one or more programs, modules, and/or routines that provide for automatic charge and/or update management of the proprietary devices 208a-b, 210, 212a and/or the charge array 216. A tour location employee and/or other information dissemination agent may, for example, utilize the controller device 220 to (i) query charge and/or update status information from the proprietary devices 208a-b, 210, 212a (e.g., in the case the proprietary devices 208a-b, 210, 212a are docked with an intelligent charging base unit such as the charge array 216 that is in communication with the controller device 220), (ii) automatically adjust charge setting of one or more proprietary devices 208a-b, 210, 212a, and/or (iii) update, re-program, and/or program one or more of the proprietary devices 208a-b, 210, 212a (such as to assign a first proprietary device 208a to a first tour group and to assign the child device 212 to a different tour group and/or to the parent device 210), as described herein.

The DDP device 230, in some embodiments, may comprise any type or configuration of a computerized processing device such as a PC, laptop computer, computer server, database system, and/or other electronic device, devices, or any combination thereof. In some embodiments, the DDP device 230 may comprise components configured to provide a subset of multimedia data stored in the local database 240b to one or more of the personal devices 214a-n. In some embodiments, the DDP device 230 may supply and/or provide multimedia content such as multimedia tour information from the controller device 2200 (e.g., stored in the remote database 240a) to the personal devices 214a-n via the local network 252b. In some embodiments, the DDP device 230 may comprise a plurality of devices. According to some embodiments, the DDP device 230 may store and/or execute specially programmed instructions to operate in accordance with embodiments described herein. In some embodiments, the DDP device 230 may comprise a plurality of processing devices specially-programmed to execute and/or conduct processes that are not practicable without the aid of the DDP device 230. The DDP device 230 may, for example, execute one or more coded rules (such as embodied in a Progressive Web Application (PWA)), filters, and/or algorithms to selectively provide a subset of stored multimedia tour content to the personal devices 214a-n, such process not being capable of being conducted (at least in a timely manner) without the benefit of the specially-programmed DDP device 230. According to some embodiments, the DDP device 230 may identify and provide a different subset of multimedia tour data to each of the different personal devices 214a-n (e.g., based on language and/or other settings of the individual personal devices 214a-n).

In some embodiments, the controller device 220 and/or the DDP device 230 (and/or the proprietary devices 208a-b, 210, 212a and/or the personal devices 214a-n) may be in communication with one or more of the databases 240a-b. The databases 240a-b may store, for example, multimedia tour data (or other multimedia data; e.g., sound, voice, image, text, and/or video data), tour group (or other group) assignment information, payment and/or ticket purchase information, stored data selection rules and/or criteria (e.g., mobile device language flags and/or rules), and/or instructions that cause various devices (e.g., the controller device 220, the DDP device 230, the proprietary devices 208a-b, 210, 212a and/or the personal devices 214a-n) to operate in accordance with embodiments described herein. The databases 240a-b may store, for example, multimedia information compiled in a format of a multimedia tour such as a narrated walking tour of a specific historic site comprising the tour location 202. In some embodiments, the databases 240a-b may comprise any type, configuration, and/or quantity of data storage devices that are or become known or practicable. The databases 240a-b may, for example, comprise an array of optical and/or solid-state hard drives configured to store multimedia tour information defined by a proprietary device 208a-b, 210, 212a interaction with the controller device 220, and/or various operating instructions, drivers, etc. While the databases 240a-b are depicted as two stand-alone components of the system 200 in FIG. 2, the databases 240a-b may comprise multiple and/or interconnected or combined components. In some embodiments, a multi-component database 240a-b may be distributed across various devices and/or may comprise remotely dispersed components. In some embodiments, and in accordance with one possible hardware topology, the remote database 240a (and/or portion thereof) may store full sets of multimedia tour (and/or other) data for a plurality of locations 202 and a selected portion or subset of the total data store may be downloaded to the local database 240b at desired intervals (e.g., nightly) based on data transformation rules specific to the DDP device 230 and/or the location 202 and/or entity associated therewith. Any or all of the proprietary device 208a-b, 210, 212a, the personal devices 214a-n, and/or the DDP device 230 may comprise the databases 240a-b or one or more portions thereof, for example, and/or the controller device 220 may comprise the databases 240a-b or one or more portions thereof.

The networks 252a-b may, according to some embodiments, comprise one or more of a Local Area Network (LAN; wireless and/or wired), cellular telephone, Bluetooth®, NFC, and/or Radio Frequency (RF) network with communication links between the controller device 220, the proprietary devices 208a-b, 210, 212a, the personal devices 214a-n, the DDP device 230, and/or the databases 240a-b. In some embodiments, the networks 252a-b may comprise direct communications links between any or all of the components 208a-b, 210, 212, 214a-n, 216, 220, 230, 240a-b of the system 200. The personal devices 214a-n may, for example, be directly interfaced or connected to the DDP device 230 via one or more wires, cables, wireless links, and/or other network components, such network components (e.g., communication links) comprising portions of the local network 252b. In some embodiments, the networks 252a-b may comprise one or many other links or network components other than those depicted in FIG. 2. The personal devices 214a-n and/or the proprietary devices 208a-b, 210, 212a may, for example, be connected to the controller device 220 via various cell towers, routers, repeaters, ports, switches, and/or other network components that comprise the Internet and/or a cellular telephone (and/or Public Switched Telephone Network (PSTN)) network, and which comprise portions of the remote network 252a.

While the networks 252a-b are depicted in FIG. 2 as a two distinct objects, the networks 252a-b may comprise any number, type, and/or configuration of networks that are or become known or practicable. According to some embodiments, the networks 252a-b may comprise a conglomeration of different sub-networks and/or network components interconnected, directly or indirectly, by the components 208a-b, 210, 212, 214a-n, 216, 220, 230, 240a-b of the system 200. The remote network 252a may comprise one or more cellular telephone networks with communication links between the charge array 216 and the controller device 220, for example, and/or may comprise the Internet, with communication links between the controller device 220 and the DDP device 230 and/or one or more of the databases 252a-b, for example.

Fewer or more components 202, 208a-b, 210, 212, 214a-n, 216, 220, 230, 240a-b, 252a-b and/or various configurations of the depicted components 202, 208a-b, 210, 212, 214a-n, 216, 220, 230, 240a-b, 252a-b may be included in the system 200 without deviating from the scope of embodiments described herein. In some embodiments, the components 202, 208a-b, 210, 212, 214a-n, 216, 220, 230, 240a-b, 252a-b may be similar in configuration and/or functionality to similarly named and/or numbered components as described herein. In some embodiments, the system 200 (and/or portion thereof) may comprise a multimedia tour (or other data) distribution and/or management program, system, and/or platform programmed and/or otherwise configured to execute, conduct, and/or facilitate the methods 600, 700, 900, 1000, 1200 of FIG. 6, FIG. 7, FIG. 9, FIG. 10, and/or FIG. 12 herein, and/or portions or combinations thereof.

### IV. Improved Bring-Your-Own-Device (BOYD) Multimedia Distribution Systems

Referring now to FIG. 3, a block diagram of a system 300 according to some embodiments is shown. The system 300 may comprise, for example, a multimedia data distribution system similar to the portion of the system 200 of FIG. 2 that may involve user-owned devices that are utilized to provide multimedia tours at tour locations. The system 300 may comprise, for example, a user device 314 (such as a smartphone, as depicted), a blade server 320, a DDP device 330 (comprising a processing device 332, network devices 334a-b, and/or a display device 336), and/or a plurality of non-transitory memory devices 340a-b (e.g., storing various instructions 342a-b and data 344a-1, 344a-2, 344b). According to some embodiments, any or all of the devices 314, 320, 330, 340a-b may be in communication via one or more networks 352a-b. In some embodiments, for example, a first or remote network device 334a of the DDP device 330 may comprise a long-range, remote, and/or Internet communications device communicatively coupled to the blade server 320 via the remote network 352a. According to some embodiments, a second or local network device 334b of the DDP device 330 may comprise a short-range, line-of-sight, and/or local communications device communicatively coupled to the user device 314 via the local network 352b.

In some embodiments, the user device 314 may initiate communications via the local network 352b such as by a user (not shown) activating or selecting a Wi-Fi® connection based on information broadcast by the local network device 352b. In some embodiments, login and/or connection instructions may be output via the display device 336 such that a user of the user device 314 may comprehend what inputs to activate on the user device 314 to establish the connection via the local network 352b. According to some embodiments, the instructions may also or alternatively be displayed via an interface 360 of the user device 314 (e.g., via a messaging or other application of the user device 314 that permits notifications from proximate devices). In such a manner, for example, the user device 314 may connect to the DDP device 330 by logging onto the local network 352b, e.g., hosted by the DDP device 330. According to some embodiments, the DDP device 330 may cause the interface 360 to be output by the user device 314, such as an interface 360 outputting information related to and/or descriptive of a multimedia tour. The interface 360 may be generated, for example, by execution of one or more coded sets of instructions 342a-b stored in one or more databases of the 340a-b. In some embodiments, a first or remote database 340a may be accessible via the blade server 320 and/or a second or local database 340b may be accessible via the DDP device 330.

The remote database 340a may store, in some embodiments, instructions defining a progressive web app 342a (or “app” or PWA), multimedia tour data 344a-1, and/or user data 344a-2. The progressive web app 342a may, in some embodiments, comprise a web application comprising at least one web page, where the progressive web app 342a utilizes a centralized web manifest file in accordance with, e.g., the “Web App Manifest: Working Draft” (Jul. 4, 2018) published by the World Wide Web Consortium (W3C) of the Massachusetts Institute of Technology (MIT) Laboratory for Computer Science (LCS), Cambridge, Mass., and/or relies upon native service workers that provide a scriptable network proxy in a web browser to manage web/HTTP requests programmatically. Information defining the term “Progressive Web App (PWA)” in accordance with some embodiments may be found at http://en.wikipedia.org/wiki/Progressive_Web_Apps, downloaded Jul. 6, 2018, the PWA descriptions and definitions of which are hereby incorporated by reference herein. In some embodiments, the multimedia tour data 344a-1 may comprise a complete multimedia tour package including audio, images, video, and/or dynamic content, including various versions, modes, and/or languages (e.g., for voice and/or text portions thereof). According to some embodiments, the user data 344a-2 may comprise account information, user identification information, ticket purchase information, credit card or other financial information, user preferences or settings, user device identification information, and/or other user-related data.

The local database 340b may store, in some embodiments, a progressive web application (or “app” or PWA) 342b that, when executed by the user device 314, causes the interface 360 to be output by the user device 314. In some embodiments, the progressive web app 342b may query and/or retrieve information from the user device 314, such as information descriptive of one or more settings of the user device 314 (e.g., a language setting). According to some embodiments, the progressive web app 342b may cause a local or subset of multimedia data 344b stored in the local database 340b to be downloaded (e.g., transmitted wirelessly) to the user device 314. In some embodiments, the user data 344a-2 stored in the remote database 340a may be utilized to verify authorization to access or download the local multimedia data 344b (i.e., a subset of the multimedia tour data 344a-1). In some embodiments, the local multimedia data 344b may be replicated, copied, and/or downloaded into the local database 340b at various intervals or on-demand. According to some embodiments, a subset and/or portion of the local multimedia data 344b may be provided to the user device 314. The setting information queried and/or retrieved from the user device 314 may be utilized, for example, to filter and/or selectively download the portion of the local multimedia data 344b to the user device 314 (e.g., in two (2) minutes or less). In a non-limiting example, in the case that the setting information defines a language setting of the user device 314, a portion of the local multimedia data 344b that is available in the specific language corresponding to the setting may be identified and provided to the user device 314. In such a manner, for example, only a small portion of the local multimedia data 344b (and accordingly, an even smaller portion of the multimedia tour data 344a-1) may need to be transmitted to the user device 314 to allow for a multimedia tour (and/or other experience) in the language that the user device 314 is set to.

Fewer or more components 314, 320, 330, 332, 334a-b, 336, 340a-b, 342a-b, 344a-1, 344a-2, 344b, 352a-b, 360 and/or various configurations of the depicted components 314, 320, 330, 332, 334a-b, 336, 340a-b, 342a-b, 344a-1, 344a-2, 344b, 352a-b, 360 may be included in the system 300 without deviating from the scope of embodiments described herein. In some embodiments, the components 314, 320, 330, 332, 334a-b, 336, 340a-b, 342a-b, 344a-1, 344a-2, 344b, 352a-b, 360 may be similar in configuration and/or functionality to similarly named and/or numbered components as described herein. In some embodiments, the system 300 (and/or portion thereof) may comprise a multimedia tour (or other data) distribution and/or management program, system, and/or platform programmed and/or otherwise configured to execute, conduct, and/or facilitate the methods 600, 700, 900, 1000, 1200 of FIG. 6, FIG. 7, FIG. 9, FIG. 10, and/or FIG. 12 herein, and/or portions or combinations thereof.

Referring now to FIG. 4, a block diagram of a system 400 according to some embodiments is shown. In some embodiments, the system 400 may comprise a multimedia data distribution system similar to the systems 200, 300 of FIG. 2 and/or FIG. 3 herein, and/or portions thereof. The system 400 may comprise, for example, a tour location 402 comprising a plurality of objects of interest 404a-c. The system 400 may also comprise, for example, a tourist 406 having a user device 414 that is in wireless communication with a server 420 and/or a DDP device 430. The DDP device 430 may receive (and/or retrieve) a web app and/or multimedia data files from the server 420 and/or a cloud storage device 440, for example, and disseminate the multimedia data files (or a subset or portion thereof) to the user device 414. In some embodiments, the web app and/or multimedia data files may only need to be downloaded to the DDP device 430 from the server 420 and/or the cloud storage device 440 once, or at intervals, such as once per month or upon an update to the web app and/or multimedia data files content. In some embodiments, the downloading of the web app and/or multimedia data files to the DDP device 430 may occur over a remote network such as the Internet 452.

According to some embodiments, once the web app and/or multimedia data files are resident at or on the DDP device 430, the user device 414 may access the DDP device 430 via a local or closed network (not explicitly shown; generally depicted by wireless transmission icons in FIG. 4), e.g., hosted by and/or in relation to the DDP device 430. The DDP device 430 may host a Wi-Fi® network, for example, and allow the user device 414 to access the web app and/or multimedia data files via the locally hosted network (e.g., a network that does not have or offer Internet access—i.e., is distinct from and not in communication with the Internet 452). As many mobile devices cannot generally download data or applications without access to proprietary online download “stores”, the web app may comprise a progressive web app that circumvents standard or approved mobile device application “stores” and permits downloading and/or execution of the content by the user device 414.

In some embodiments, the DDP device 430 may comprise a plurality of devices dispersed throughout the specific location 402 such as a tourist site, such that proximity of a user device 414 to one of the DDP device 430 causes the progressive web application to activate and/or download a certain subset of content to the user devices 414. According to some embodiments, the DDP device 430 may comprise a device provided to a tourist 406 upon entry to the tour location 402, the DDP device 430 being responsive to locational repositioning to activate certain routines (e.g., via the progressive web application). In such a manner, for example, a specific subset of content stored on the DDP device 430 may be activated and/or provided to a user device 414 in location-relevant context (e.g., data descriptive of a first object 404a and/or a second object 404b, both in the same first room “A” as the tourist 406, may be prioritized and/or selected for immediate download).

Instead of being required to rely upon cellular or public wireless access to the Internet 452 to download an application or tour content, for example, the tourist 406 may approach the DDP device 430 upon entering a first room “A” of the location 402 and undertake a few simple actions that may provide an attractive alternative to previous systems. In some embodiments, for example, the DDP device 430 may comprise a display or other output device (not separately show in FIG. 4) that outputs instructions for acquiring and/or activating a progressive web application stored on or by the DDP device 430. The DDP device 430 may display a message and/or output a signal, for example, prompting the tourist 406 to connect the user device 414 to the local Wi-Fi® hosted by the DDP device 430 (e.g., at a first position “1” in FIG. 4). Once the tourist 406 connects the user device 414 to the DDP device 430, the DDP device may query one or more setting parameters of the user device 414, such as a language or preference setting. According to some embodiments, the DDP device 430 may utilize the language, preference, and/or other setting parameter information (e.g., a retrieved numeric value or code) to identify and/or select a subset of multimedia tour data stored on or by the DDP device 430. In such a manner, for example, the size of the content to be transmitted to the user device 414 is greatly reduced.

In some embodiments, the DDP device 430 may then transmit the subset of the multimedia data to the user device 414. According to some embodiments, a progressive web application may also or alternatively be downloaded to the user device 414 (e.g., via the locally-hosted Wi-Fi® connection). In some embodiments, portions of the subset of multimedia data that correspond to a discrete location of the tourist 406 and/or user device 414 may be downloaded to the user device 414 first, before other portions of the subset, further minimizing the size/amount of data that needs to be transmitted prior to the tourist 406 beginning their tour. Accordingly, the tourist 406 may leave the DDP device 430 and move to a second position “2” at the location 402, such as near the second object 404b. In some embodiments, the progressive web application may trigger a provision of multimedia content (e.g., a downloaded subset and/or portion of a subset—e.g., a portion descriptive of the second object 404b in a particular language such as English) to the tourist 406 via the user device 414 upon the tourist 406 becoming proximate to the second object 404b (e.g., within a certain predetermined threshold distance (measured or inherent—such as within a Bluetooth® Low-Energy (LE) signal range) and/or upon receiving a triggering command from the tourist 406 (e.g., activation of a “start” or “play” button—not shown). In some embodiments, additional portions of the subset of data may be downloaded to the user device 414 while the tourist 406 begins the tour by listening to and/or viewing the first portion of the subset of data descriptive of the second object 404b, e.g., as a background process on the user device 414.

According to some embodiments, upon arrival in a specific room of a building, a second room “B” at the tour location 402 for example, the DDP device 430 may activate and/or provide a second portion and/or second subset of content stored in association with the specific room “B” and/or with respect to a particular third object 404c located in the second room “B”. Similarly, in the case that the DDP device 430 is positioned near a specific object (e.g., the first object 404a) and/or data from the user device 414 (e.g., camera feed data) indicates a position proximate to the third object 404c, an appropriate corresponding subset of content stored in association with the object 404a, 404c may be retrieved and/or provided.

Upon the tourist 406 moving to a third position “3” in the second room “B”, for example, the DDP device 430 may be activated to provide additional content that had not yet been downloaded to the user device 414. In such a manner, for example, the amount of content necessary to download to the user device 414 may be reduced by limiting downloaded content to discrete location-based triggering events (i.e., only downloading content relevant to areas of the location 402 that are actually visited by the tourist 406). In some embodiments, the progressive web application of the user device 414 may trigger location-based downloads of portions and/or subsets of the content. According to some embodiments, upon arrival at the third position “3”, the user device 414 may detect a signal and/or field generated in association with the third object 404c. An additional DDP device 430 (not separately depicted) in the second room “B” and/or another electronic device such as a near-field and/or BLE® beacon proximate to the third object 404c may, for example, broadcast a signal that is detected by the progressive web application and/or the user device 414. In response to the detecting, the progressive web application and/or the user device 414 may transmit a triggering signal to the DDP device 430 to initiate additional and/or location-contextual information downloading to the user device 414.

Fewer or more components 402, 404a-c, 406, 414, 420, 430, 440, 452 and/or various configurations of the depicted components 402, 404a-c, 406, 414, 420, 430, 440, 452 may be included in the system 400 without deviating from the scope of embodiments described herein. In some embodiments, the components 402, 404a-c, 406, 414, 420, 430, 440, 452 may be similar in configuration and/or functionality to similarly named and/or numbered components as described herein. In some embodiments, the system 400 (and/or portion thereof) may comprise a multimedia tour (or other data) distribution and/or management program, system, and/or platform programmed and/or otherwise configured to execute, conduct, and/or facilitate the methods 600, 700, 900, 1000, 1200 of FIG. 6, FIG. 7, FIG. 9, FIG. 10, and/or FIG. 12 herein, and/or portions or combinations thereof.

### V. Bring-Your-Own-Device (BOYD) Multimedia Distribution Interfaces

Turning now to 5A, FIG. 5B, FIG. 5C, FIG. 5D, FIG. 5E, FIG. 5F, FIG. 5G, FIG. 5H, and FIG. 5I, diagrams of a system 500 comprising a user device 514 that provides/outputs example interfaces 560a-e according to some embodiments are shown. In some embodiments, the interfaces 560a-i may comprise one or more web pages, web forms, database entry forms, API objects, spreadsheets, tables, and/or applications or other GUI elements via which a user or other entity (not shown) may enter data (e.g., provide or define input via a haptic interface and/or wireless device transmissions) to enable receipt of selectively and locally-downloaded multimedia content (e.g., multimedia tour content), as described herein. According to some embodiments, the interfaces 560a-i may be generated and/or output by a progressive web application as described herein. The progressive web application may cause an outputting of the interfaces 560a-i and may, for example, comprise or define a digital multimedia content distribution and/or dissemination program and/or platform programmed and/or otherwise configured to execute, conduct, and/or facilitate the methods 600, 700, 900, 1000, 1200 of FIG. 6, FIG. 7, FIG. 9, FIG. 10, and/or FIG. 12 herein, and/or portions or combinations thereof. In some embodiments, the interfaces 560a-i may be output via one or more other computerized devices (not show), such as the DDP device 230, 330, 430, 730 of FIG. 2, FIG. 3, FIG. 4, and/or FIG. 7 herein.

According to some embodiments, the interfaces 560a-i may comprise instructions for downloading automatically filtered and/or selectively parsed content via a DDP device. In a first version (or page or instance) of the interface 560a (shown in FIG. 5A), for example, an introductory instructive message may be output that requests that the user activate the short-range and/or wireless network (e.g., Bluetooth® and/or Wi-Fi®) setting of their mobile device 514, e.g., to selectively connect to a local and/or Wi-Fi® network hosted by the DDP device. According to some embodiments, the same or similar message may be by the DDP device, such as in the case that the DDP device comprises a display device visible to visitors/tourists of a tour location. The first version of the interface 560a may, for example, mirror an interface caused to be displayed by the DDP device. As depicted in FIG. 5A, for example, the first interface 560a may comprise a first textual instruction or message 562a, e.g., “Please turn on your Wi-Fi to install your Tour.” In some embodiments, the first interface 560a may comprise a first action button 564a (e.g., labeled “Turn on Wi-Fi”) that may be activated to initiate a script that causes a first programmatic action on the user device 514. According to some embodiments, activation of the first action button 564a by the user (e.g., a receipt of first user input via the first interface 560a) may cause a generation of and/or navigation to a second version (or page or instance) of the interface 560b (shown in FIG. 5B).

According to some embodiments, the second version of the interface 560b may comprise a wireless network menu screen that may, for example, be native to the user device 514 (e.g., which may have been called by an activation of the first action button 564a). In some embodiments, the second interface 560b may comprise a second textual instruction or message 562b, e.g., “Choose a network . . . ”, a second action button 564b that enables the short-range communications (e.g., Wi-Fi®) of the user device 514 to be toggled on or off, and/or a listing of a plurality of available networks 566b-1, 566b-2, 566b-3. In some embodiments, the user may be prompted (via the user device 514 and second interface 560b and/or via the DDP device) to select an appropriate available Wi-Fi® network 566b-1, 566b-2, 566b-3 that corresponds to the DDP device. In the example depicted in FIG. 5B, the use may have selected a third one of the available networks 566b-3 labeled “Museum Tour”, as shown in a highlighted background color. In such a manner, for example, the user may be quickly and easily directed to connect to the local network hosted by the DDP device.

In some embodiments, such as once a tourist/user has enabled their wireless communications and/or activated a connection between their user device 514 and the DDP device (e.g., by selection of the third one of the available networks 566b-3 via the second version of the interface 560b), a third version (or page or instance) of the interface 560c (shown in FIG. 5C) may be output and/or provided. The third version of the interface 560c may, for example, output a third textual instruction or message 562c comprising a confirmation that the connection and/or communication session has been enabled and/or provide a third action button 564c that comprises a prompt and/or link to a progressive web application (e.g., “Install Museum Tour”). According to some embodiments, the same or similar message may be output or displayed via the DDP device. The third version of the interface 560c may, for example, mirror an interface caused to be displayed on the DDP device. In some embodiments, the third action button 564c may comprise a link and/or interactive graphical feature that when activated by the user causes an execution of the progressive web app (e.g., by initiating one or more service worker scripts of a web browser of the user device 514).

Turning to FIG. 5D, a fourth version (or page or instance) of the interface 560d may comprise a notification activation screen. The fourth version of the interface 560d may comprise, for example, a fourth textual instruction or message 562d (e.g., “Never miss a Museum Tours notification by getting them right on your device”) and/or a fourth action button 564d (e.g., “Turn on Notifications”), prompting the user to activate the fourth action button 564d to allow or enable the progressive web application to send notifications to the user (e.g., via the user device 514). In such a manner, for example, upon activation of the fourth action button 564d a script may execute that changes a value or setting of the user deice 514 to enable the progressive web application to send “push” notifications to the user. In some embodiments, push notification from the progressive web application may be utilized to provide dynamic directions to the user (e.g., to advise the user when and/or where to turn at a tour location, to announce upcoming scheduled activities or programs at the tour location, and/or the advise the user of restricted areas, fire alarms, or other emergencies or important announcements relating to the tour location and/or the specific location of the user device 514 at the tour location), advise the user that location-specific content is available, etc.

According to some embodiments, a fifth version (or page or instance) of the interface 560e (shown in FIG. 5E) may comprise a home page installation screen. The fifth version of the interface 560e may comprise, for example, a pop-up menu 568 that prompts the user to add the progressive web application to the home screen of the user device 514. The pop-up menu 568 may comprise, in some embodiments, a progressive web application icon or badge 568-1 (e.g., as it will/would appear on the home screen), a cancel link or button 568-2, and/or an automatic add link or button 568-3. The cancel link or button 568-2 may permit the user to forgo adding the application badge 568-1 to the home screen, while the automatic add button 568-3 may, upon selection and/or initiation by the user, cause an execution of a script that adds the application badge 568-1 on a home screen (e.g., graphical application listing) of the user device 514. In such a manner, for example, the user may quickly and easily embed or install a shortcut or launch mechanism (e.g., the application badge 568-1) on the user device 514, such that subsequent initiations of the progressive web application may emulate or simulate the look and feel of the user launching a native application on the user device 514.

In some embodiments, a sixth version (or page or instance) of the interface 560f (shown in FIG. 5F) may comprise a loading page or screen. The sixth version of the interface 560f may comprise, for example, a sixth message 562f comprising a loading graphic that provides an indication of a loading progress of the progressive web application. As the progressive web application is a relatively small application file delivered over a local (e.g., non-Internet enabled) network hosted by the DDP device, loading times are expected to be short, and the loading graphic 562f may only be utilized for a short amount of time to maintain the user's attention and as an indication to the user that installation is occurring. According to some embodiments, once the loading of the progressive web application is complete, the loading graphic 562f and/or the sixth version (or page or instance) of the interface 560f may be replaced by and/or may cause a generation of a seventh version of the interface 560g. In some embodiments, the seventh version of the interface 560g (shown in FIG. 5G) may be otherwise provided, triggered, and/or generated (e.g., in the case that the sixth version of the interface 560f is not utilized in the system 500). According to some embodiments, the seventh version of the interface 560g may comprise a seventh textual instruction or message 562g comprising an initiation of a welcome message to be presented to the user (e.g., via the user's mobile device 514 and/or via the DDP device). According to some embodiments, the same or similar message may be output by the DDP device. The seventh version of the interface 560g may, for example, mirror an interface caused to be displayed on the DDP device once the progressive web application has been installed and/or initiated on the user device 514. In some embodiments, the welcome message 562g may comprise a video and/or animated script that captures the user's attention while data processing and/or transmission occurs in the background. Once the user activates the progressive web app and the welcome message 562g plays, for example, the progressive web app may automatically retrieve setting information from the user device 514, utilize the setting information and stored rules or logic to define and/or identify a subset of locally-stored multimedia content (e.g., a multimedia tour in a specific spoken language), and initiate a downloading and/or transmission of the subset of selected content to the user device 514.

According to some embodiments, an eighth version (or page or instance) of the interface 560h (shown in FIG. 5H) may comprise an access screen. The eighth version of the interface 560h may comprise, for example, an eighth textual instruction or message 562h prompting the user to input an access code, PIN, and/or other identifier or credential, e.g., “Please enter your visitor access code from your ticket:”. In some embodiments, the eighth version of the interface 560h may comprise one or more action items 564h-1, 564h-2. A first action item 564h-1 may comprise, for example, an alphanumeric entry box, form, or other data input mechanism. According to some embodiments, as depicted in FIG. 5H, the first action item 564h-1 may comprise an input area for a code associated with a ticket that the user has previously purchased (e.g., a ticket to the tour location, for a group device-facilitated tour, etc.). In some embodiments, such a code or information from the user's ticket (printed or digitally rendered) may be acquired by means other than direct user input via the first action item 564h-1. The second action item 564h-2 may comprise, for example, a link or button that activates a camera or other input device (not shown in FIG. 5H) of the user device 514 so that the user may scan or image a barcode or other computer-readable indicia from the ticket (e.g., “Or click here to scan barcode . . . ”). In such a manner, for example, the progressive web application may only allow downloading and/or access to multimedia tour content to users that have already purchased a ticket to the tour location. According to some embodiments, different codes and/or identifiers may be utilized to allow downloading and/or access to different portions and/or subsets of tour data. Ticketing and/or facility access may be conducted by facility staff, for example, and different codes (e.g., barcodes) may be available inside of the facility/location, such that only those that have access to the facility may scan the appropriate barcode to proceed from the eighth version of the interface 560h.

In some embodiments, once the welcome message 562g completes and/or once a code entered via the eighth version of the interface 560h has been authenticated and/or verified, a ninth version (or page or instance) of the interface 560i may be output and/or provided. As depicted in FIG. 5I, for example, the user device 514 (and/or the DDP device) may output a ninth textual instruction or message 562i prompting the user to “Enjoy your tour!”, which is an indication that the automatically selected/filtered subset of the multimedia content is ready for consumption on the user device 514. In some embodiments, the ninth version of the interface 560i may also or alternatively comprise an action item 564i comprising an interactive graphical element such as the depicted “play” arrow via which the user may initiate an outputting of the automatically selected/filtered subset of the multimedia content. According to some embodiments, the same or similar message may be output by the DDP device. The ninth version of the interface 560i may, for example, mirror an interface caused to be displayed on the DDP device. In such a manner, for example, once the welcome message has completed, the user may have access to view, listen to, and/or otherwise consume the automatically selected/filtered subset (and/or portion) of the multimedia content that is now stored on the user device 514. Because the automatically selected/filtered subset of the multimedia content is stored on the user device 514, the user may consume the content offline (e.g., walk away and/or disconnect from the local network hosted by the DDP device). Accordingly, user's may benefit from multimedia content deliver that is quick, takes up less storage space than other alternatives (e.g., on account of being filtered and/or segmented logically based on settings of the user device 514 and/or based on user-defined settings and/or location), and preserves Internet and/or cell-phone network bandwidth at tourist (and/or other) locations.

While various components of the interface 560a-i have been depicted with respect to certain labels, layouts, headings, titles, and/or configurations, these features have been presented for reference and example only. Other labels, layouts, headings, titles, and/or configurations may be implemented without deviating from the scope of embodiments herein. Similarly, while a certain number of tabs, information screens, form fields, and/or data entry options have been presented, variations thereof may be practiced in accordance with some embodiments. While the DDP device is generally described and/or depicted herein as a wirelessly-enabled display device coupled with progressive web app execution capability, other variations and/or configurations of the DDP device may be implemented without deviating from some embodiments. The DDP device may comprise, for example, a wireless network storage dongle such as the SanDisk® Wireless Stick available from Western Digital Technologies, Inc. of Milpitas, Calif., that does not include a display device. Such a wireless storage dongle may, for example, connect to the user's mobile device (directly and/or wirelessly) and provide access to the progressive web app and the filtered/segmented multimedia content.

### VI. Bring-Your-Own-Device (BOYD) Multimedia Distribution Methods

Turning now to FIG. 6, a flow diagram of a method 600 according to some embodiments is shown. In some embodiments, the method 600 may be performed and/or implemented by and/or otherwise associated with one or more specialized and/or specially-programmed computers (e.g., the DDP devices 230, 330, 430, 730 of FIG. 2, FIG. 3, FIG. 4, and/or FIG. 7 herein), specialized computers, computer terminals, computer servers, computer systems and/or networks, and/or any combinations thereof (e.g., by one or more multi-threaded and/or multi-core processing units comprising a digital distribution hub at a multimedia tour location). In some embodiments, the method 600 may be embodied in, facilitated by, and/or otherwise associated with various input mechanisms and/or interfaces (e.g., the interfaces 360, 560a-i, 1360 of FIG. 3, FIG. 5A, FIG. 5B, FIG. 5C, FIG. 5D, FIG. 5E, FIG. 5F, FIG. 5G, FIG. 5H, FIG. 5I, and/or FIG. 13 herein).

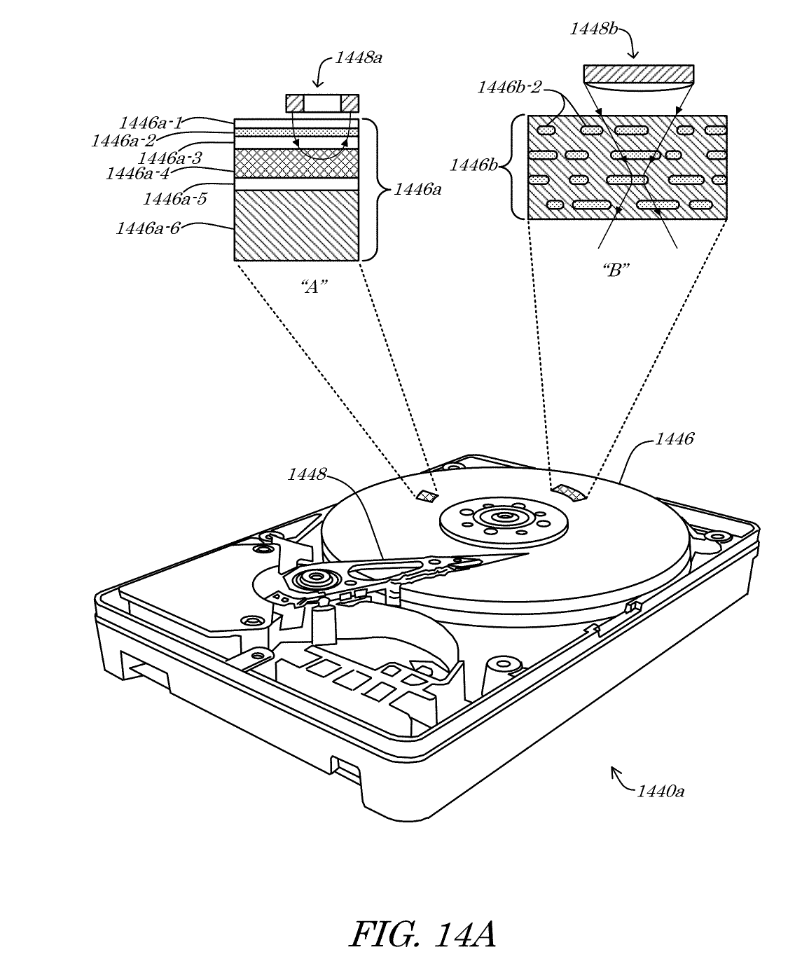

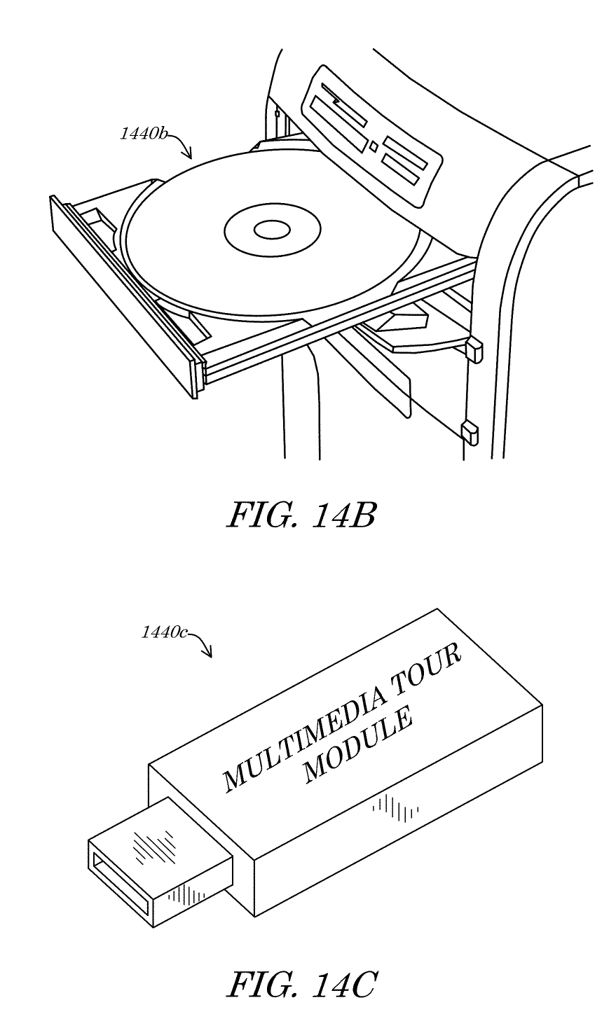

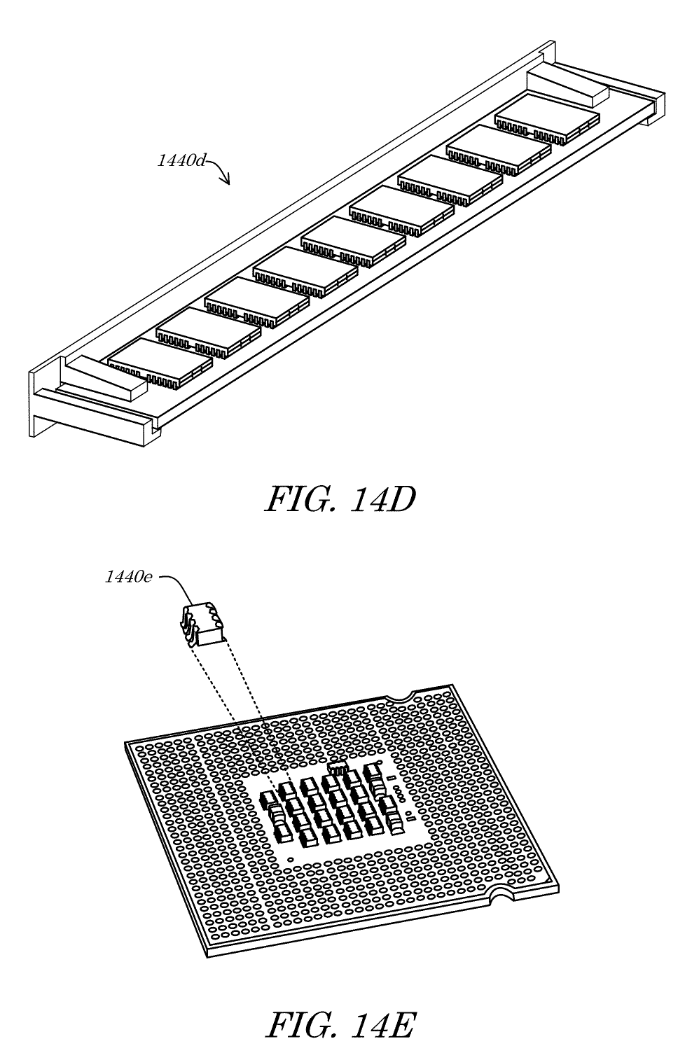

The process diagrams and flow diagrams described herein do not necessarily imply a fixed order to any depicted actions, steps, and/or procedures, and embodiments may generally be performed in any order that is practicable unless otherwise and specifically noted. While the order of actions, steps, and/or procedures described herein is generally not fixed, in some embodiments, actions, steps, and/or procedures may be specifically performed in the order listed, depicted, and/or described and/or may be performed in response to any previously listed, depicted, and/or described action, step, and/or procedure. Any of the processes and methods described herein may be performed and/or facilitated by hardware, software (including microcode), firmware, or any combination thereof. For example, a storage medium (e.g., a hard disk, Random Access Memory (RAM) device, cache memory device, Universal Serial Bus (USB) mass storage device, and/or Digital Video Disk (DVD); e.g., the data storage devices 240a-b, 340a-b, 440, 740a-b, 1340, 1440a-e of FIG. 2, FIG. 3, FIG. 4, FIG. 7, FIG. 13, FIG. 14A, FIG. 14B, FIG. 14C, FIG. 14D, and/or FIG. 14E herein) may store thereon instructions that when executed by a machine (such as an electronic and/or computerized processing device) result in performance according to any one or more of the embodiments described herein.

According to some embodiments, the method 600 may comprise receiving (e.g., via a central controller or server) a request to purchase tickets and/or an electronically-enhanced tour (or other multimedia content), at 602. A consumer/user may interface with the server via a webpage or website over the Internet, prior to arriving at a tour location for example, and may purchase tickets to a tourist attraction along with a multimedia tour for the attraction/location. In some embodiments, the controller/server may provide the user with a code or identifier that represents the purchase and/or authorization to retrieve multimedia content for the desired tour. According to some embodiments, the server may store purchase and/or authorization information in a database, such as for future use in authorizing downloadable multimedia content.

In some embodiments, the method 600 may comprise outputting (e.g., via a display device of a digital distribution point at the tourist attraction location and/or to a mobile device of a tourist) instructions for connecting to a local network, at 604. As described herein, for example, instead of requiring users that bring their own mobile electronic devices to the tourist attraction location to pre-download a multimedia tour and/or mobile device application for the tour or requiring that they download on-site via the Internet (e.g., utilizing an “app store”), the digital distribution point (or points) may host a short-range wireless network (e.g., Bluetooth® and/or Wi-Fi®) via which users may download an automatically selected subset of the multimedia tour data for the location. Such a mechanism for digital content distribution is believed to significantly reduce multimedia data acquisition times and accordingly increase consumer retention and engagement, which in turn should increase profitability. In some embodiments, the instructions may be automatically transmitted to a mobile electronic device of the user as the user approaches (e.g., comes within broadcast range of) the digital distribution point at the tourist attraction location. The digital distribution point may transmit and/or cause the outputting of (e.g., via a display and/or other output device of the user's mobile electronic device) instructions via the user's device, for example, prompting the user to provide specified input to their device (e.g., to make certain changes to the settings to allow connection to the local network, such as by selecting the appropriate Service Set Identifier (SSID) from a list of available network IDs).

According to some embodiments, the method 600 may comprise receiving (e.g., via the digital distribution point at the tourist attraction location and/or from the mobile device of the tourist) a request to connect to the local/short-range wireless network, at 606. The user, having seen the instructions displayed via the display device (of the digital distribution point and/or of their own mobile electronic device), for example, may instruct their mobile electronic device to connect to the local wireless network of the digital distribution point. According to some embodiments, such as in the case that the user has previously connected their mobile device to the same or similarly-named and/or authenticated network, the connection request may occur automatically (e.g., without user input being required). The user's mobile device may be set to automatically reconnect to the local network when in-range, for example.

In some embodiments, the method 600 may comprise initiating a communication session with the user's mobile electronic device via the local wireless network. According to some embodiments, the digital distribution point may utilize this connection/session to initiate a script to automatically retrieve setting and/or other information from the user's mobile electronic device and utilize such information to execute one or more stored rules and/or filters. As a continuing and non-limiting example herein, in some embodiments the script may be coded to, and the method 600 may comprise, retrieving language setting information from the user's mobile electronic device, at 608. According to some embodiments, the language setting information may be utilized to identify and/or select (e.g., based on stored rules) a subset or portion of locally-stored multimedia content for distribution to the user's mobile electronic device, at 610. In the case that a multimedia tour for the tourist location is stored in a plurality of different languages (e.g., English, German, Polish), for example, a user device setting of “English” (or a parameter value corresponding thereto) may cause the digital distribution point to select an “English” version of the multimedia content (e.g., an electronically-enhanced tour) and initiate a download of the selected subset of the multimedia data to the user's mobile electronic device (e.g., over the local/short-range wireless network). In such a manner, for example, Internet bandwidth usage is minimized (as the content is both pared-down and provided locally) and consumer wait times for the content are drastically reduced—increasing consumer satisfaction and retention.

According to some embodiments, the method 600 may comprise outputting (e.g., via the digital distribution point at the tourist attraction location and/or via the user's mobile electronic device) an introductory message and/or transmitting the subset of the multimedia content, at 612. The introductory message may comprise, for example, a multimedia (e.g., video and audio) presentation designed to capture the user's attention while the subset of the multimedia content is downloaded to the user's device. In some embodiments, the introductory or “masking” message (e.g., it “masks” the time spent downloading) may be initiated and/or conducted by a progressive web application installed on the user's mobile device.

In some embodiments, the method 600 may also or alternatively comprise outputting an authentication prompt. The progressive web app may cause, for example, an interface to be output via the user's device that requests an activation or PIN code (e.g., the eighth version of the interface 560h of FIG. 5H herein). According to some embodiments, the code may have been provided to the user in the case that the user pre-purchased their tourist attraction tickets and/or multimedia tour online. In some embodiments, the digital distribution point may receive a code input by the user (e.g., via the short-range network) and may compare the code to stored information to authenticate the user's access to the downloaded subset of the multimedia content. According to some embodiments, the digital distribution point may communicate with a remote server (e.g., via a second or long-range network such as the Internet) to verify the authenticity of the provided code.

According to some embodiments, in the case that the code is verified, the progressive web app may provide access to the downloaded subset of the multimedia content and the user may accordingly begin their electronically-enhanced tour (and/or other experience, depending upon the subject matter of the downloaded data). In some embodiments, even once downloaded, the multimedia tour (e.g., the downloaded subset and/or portion of the tour resident on the user's mobile device) may only be accessible via the progressive web application. The section of stored data on the user's device that corresponds to the downloaded tour may, for example, be encoded, encrypted, and/or otherwise secured such that access thereto may only be possible by activation and utilization of the progressive web application. In such a manner, for example, proprietary tour content may only be accessible to individuals that have (i) purchased a ticket to an associated facility or location, (ii) have purchased a particular tour package, (iii) are members of a specific tour group, and/or (iv) maintain a certain account or status to maintain the operational integrity of the progressive web application. In some embodiments, in the case that the progressive web application is disable, deleted, or uninstalled, the associated tour content may be removed, deleted, and/or altered.

Referring now to FIG. 7, a flow diagram of a systemic method 700 according to some embodiments, is shown. The method 700 may, for example, be executed by various hardware and/or logical components via interactive communications, such as may involve communications between a mobile electronic device 714, a remote server 720, and/or a DDP device 730. In some embodiments, the DDP device 730 may comprise a processing unit 732. In some embodiments, the DDP device 730 and/or the mobile electronic device 714 may comprise network devices 734a-c, Input/Output (I/O) devices 736a-b, and/or memory devices 740a-b. While not explicitly depicted in FIG. 7, the devices and/or components 714, 720, 730, 732, 734a-b, 736a-b, 740a-b may be in communication via various networks and/or network components, and/or may process received data by executing instructions via one or more electronic processing devices.

In some embodiments, the method 700 (e.g., for selectively distributing subsets and/or portions of multimedia tour data to users) may begin at “1” with the processing unit 732 of the DDP device 730 initiating a transmission of a request for multimedia content via a first (or long-range) network device 734a (such as an Ethernet, broadband, and/or other connection device in communication with the Internet or a remote private network). The first network device 734a may, for example, transmit the request to the remote server 720, and/or the remote server 720 may receive the request, at “2”. According to some embodiments, the request at “1” and “2” may otherwise comprise an initiation of communications between the remote server 720 and the DDP device 730. In some embodiments, upon receipt of the request the remote server 720 may identify multimedia data for the DDP device 730 from a plurality of available multimedia data files and/or objects, at “3”. In the case that the DDP device 730 is installed and/or otherwise disposed at a specific tour location, for example, the remote server 720 may identify and/or select, e.g., based on an identifier of the DDP device 730, the multimedia content from a plurality of available content (e.g., stored on, in, or by the remote server 720).

According to some embodiments, the remote server 720 may transmit the selected multimedia content (e.g., filtered and/or selected specifically for the DDP device 730) to the first network device 734a, at “4”. In the case that the request at “1” and “2” comprises a query or retrieval request (e.g., a data pull request), the transmitting at “4” may be specifically conducted in response thereto. In some embodiments, such as in the case that the request at “1” and “2” comprises an initiation of communications (e.g., a registration and/or “handshake”), the transmitting at “4” may be conducted in response to one or more other triggers or events. The transmitting at “4”, for example, may comprise a scheduled data “push” that automatically sends new and/or updated multimedia tour content data to the DDP device 730. In some embodiments, the multimedia tour content may be transmitted by the first network device 734a to a first or local memory 740a of the DDP device 730, at “5”. According to some embodiments, the storage of the multimedia content may be segmented into different portions and/or sectors that correspond to different artifacts, objects, and/or areas or discrete locations within or at the tour location.

In some embodiments, the processing unit 732 may send a signal to a display device 736a of the DDP device 730, the signal causing the display device 736a to output instructions for connecting to a second (or local) network device 734b, at “6”. According to some embodiments, the processing unit 732 may also or alternatively send a signal to the local network device 734b that causes the local network device 734b to output or broadcast a signal or field, at “7”. In some embodiments, the broadcast or transmission by the local network device 734b may comprise the instructions for connecting. According to some embodiments, the broadcast and/or transmitted signal may be received by a third (or mobile) network device 734c of the mobile electronic device 714, at “8”. In some embodiments, information based on and/or descriptive of the broadcast or transmission from the DDP device 730 may be output by an I/O device 736b of the mobile electronic device 714, at “9”. In the case that the broadcast/transmission comprises an identification of the local network hosted by the DDP device 730, for example, the existence or availability of the network may be output to the user. According to some embodiments, the broadcast/transmission includes human-readable instructions for connecting the mobile electronic device 714 to the DDP device 730, and such instructions may be output to the user, at “9”.

According to some embodiments, the user may view the instructions and/or output and provide input via the I/O device 736b in response to the instructions and/or output, at “10”. The user may, for example, execute the instructions by making certain selections and/or entering certain data into the I/O device 736b. In the case that the instructions request that the user open a settings menu and select a listing corresponding to the local network hosted by the DDP device 730, for example, the input of the user at “10” may comprise a selection of the appropriate network listing. In some embodiments, the input may be transmitted from the I/O device 736b and to the mobile network device 734c, at “11”. The input data may then, for example, be transmitted to and/or retrieved by the local network device 734b, at “12”. The input data may comprise or bed defined as, in accordance with some embodiments, a request for a local network connection to be established between the mobile electronic device 714 and the DDP device 730 (and/or the local network device 734b thereof). According to some embodiments, the connection request may be sent to the local network device 734b at “12” without receiving input from the user (e.g., the connection request may occur automatically).

In some embodiments, the local network device 734b may provide or transmit the connection request to the processing unit 732, at “13”. According to some embodiments, the processing unit 732 may, in response to the connection request, generate or identify a settings query, at “14”. Information in the connection request may, for example, comprise an identifier of the make, model, capacity, and/or other characteristic information descriptive of the mobile electronic device and/or the user thereof. Such information may be utilized by the processing unit 732 to identify one or more desired setting and/or preference parameters for which values are desired. In some embodiments, the processing unit 732 may transmit the query to or through the local network device 734b, at “15”, and/or the local network device 734b may transmit or forward the query to the mobile network device 734c (and/or the mobile electronics device 714), at “16”. In accordance with some embodiments, the query may be utilized to interrogate and/or search a mobile memory 740b, at “17”. The query may be utilized to identify the desired parameter value and/or other setting or preference information stored in the mobile memory 740b, at “18” for example. In some embodiments, the query results (e.g., setting parameter value(s)) may be sent from the mobile memory 740b to the mobile network device 734c, at “19”, and forwarded from the mobile network device 734c to the local network device 734b, at “20”.

According to some embodiments, the query results may be provided to the processing unit 732, at “21”. The processing unit 732 may then, for example, execute stored logic and/or apply stored rules that utilize the query results (e.g., one or more mobile device setting or preference parameters values) to identify a subset and/or portion of the multimedia data that should be downloaded to the mobile electronic device 714, at “22”. In the ongoing and non-limiting example of a language setting of the mobile electronic device 714, for example, the query may comprise a query for the language setting (e.g., tailored to a specific model cell phone and/or a specific operating system and/or file storage structure associated with the mobile electronic device 714) and the query result may comprise a value indicative of the setting (e.g., “English” or “3” for Polish). In some embodiments, the language setting (or other retrieved value) may be utilized to identify a specific subset or portion of the multimedia data. In the case that the language setting of the mobile electronic device 714 is English, for example, a subset or version of the multimedia content in the English language may be identified for downloading to the mobile electronic device 714. In such a manner, for example, a much smaller data set and/or file size may need to be downloaded, drastically increasing download speed and greatly diminishing user wait times. According to some embodiments, subsets, portions, and/or versions of the multimedia tour data/content may similarly be identified and/or selected based on location information descriptive of a location of the mobile electronic device 714 (e.g., absolute location such as a GPS coordinate or relative location information, such as within a known network or other electronic and/or magnetic field range).

In some embodiments, the identified subset of data may be called and/or queried from the local memory 740a, at “23”. The subset of data may then be provided to the local network device 734b, at “24”, and transmitted to the mobile network device 734c, at “25”. According to some embodiments, the mobile electronic device 714 may save or download the subset of data into the mobile memory 740b, at “26”. In some embodiments, some or all of the downloaded subset of data may then be called or retrieved by the mobile electronic device 714, e.g., in response to an execution of a progressive web application stored and executed thereon, at “27”. The subset of content may be provided to the user via the I/O device 736b, e.g., as part of a multi-media and/or device-guided tour of the location (or a portion thereof, such as a first floor or room, with additional subsets of content for additional floors/rooms being downloaded upon entry of the mobile electronic device 714 into those areas, respectively), at “28”.

While many specific actions of the method 700 have been described with respect to FIG. 7, fewer or more actions, transmissions, and/or processing procedures may be implemented in the method 700 without deviating from embodiments herein. In some embodiments, fewer or more components 714, 720, 730, 732, 734a-b, 736a-b, 740a-b and/or various configurations of the depicted components 714, 720, 730, 732, 734a-b, 736a-b, 740a-b may be included in the method 700 without deviating from the scope of embodiments described herein. In some embodiments, the components 714, 720, 730, 732, 734a-b, 736a-b, 740a-b may be similar in configuration and/or functionality to similarly named and/or numbered components as described herein. In some embodiments, the method 700 (and/or one or more portions thereof) may comprise a multimedia tour (or other data) distribution and/or management program, system, and/or platform programmed and/or otherwise configured to execute, conduct, and/or facilitate the other methods 600, 900, 1000, 1200 of FIG. 6, FIG. 9, FIG. 10, and/or FIG. 12 herein, and/or portions or combinations thereof.

### VII. Proprietary Device Multimedia Distribution Systems

Referring now to FIG. 8, a block diagram of a system 800 according to some embodiments is shown. The system 800 may comprise, for example, a multimedia data distribution system similar to the portion of the system 200 of FIG. 2 that may involve proprietary devices that are utilized to provide multimedia tours at tour locations. The system 800 may comprise, for example, a tour location 802 for which a multimedia tour is desired and a plurality of devices 808a-b, 810, 812a-b, 814 communicatively coupled to facilitate and/or manage multimedia tour delivery. The system 800 may comprise, for example, one or more proprietary user devices 808a-b, one or more group tour parent devices 810, one or more group tour child devices 812a-b, and/or a multimedia tour management device 814. According to some embodiments, some or all of the devices 808a-b, 810, 812a-b, 814 may be electrically and/or communicatively coupled to a charging array 816 comprising and/or defining a plurality of charging bays 818a-b. In some embodiments, the system 800 may comprise a server stack 820 (comprising various individual servers 820a-e) in communication with one or more data storage devices 840a-b and/or one or more network devices 850a-b (e.g., a router 850a and/or a switch 850b) coupled to permit communications, via a network 852, between the charging array 816 and the server cluster 820.

According to some embodiments, the charging array 816 may comprise a first charging bay 818a and a second charging bay 818b, each being electrically (e.g., for charging) and communicatively coupled to a wireless network device 816-1 via a hub 816-2. The hub 816-2 may, for example, distribute and/or direct electrical charging current and/or data communication signals to and/or from any devices docked in the charging bays 818a-b, such as a first proprietary user device 808a (docked in a first slot (“A”) of the first charging bay 818a), a second proprietary user device 808b (docked in a second slot (“B”) of the first charging bay 818a), the group tour parent device 810 (docked in a second slot (“F”) of the second charging bay 818b), a first group tour child device 812a (docked in a third slot (“G”) of the second charging bay 818b), and/or a second group tour child device 812b (docked in a fourth slot (“H”) of the second charging bay 818b). In some embodiments, the hub 816-2 may comprise a low-voltage device that transmits and/or directs power and/or communications to and/or from the docked devices 808a-b, 810, 812a-b in accordance with the Universal Serial Bus (USB) 2.0 or 3.1/3.2 (“SuperSpeed”/“SuperSpeed+”) specifications published by the USB Implementers Forum (USB-IF) of Beaverton, Oreg.

In some embodiments, various data from the docked devices 808a-b, 810, 812a-b may be transmitted (e.g., as source-identifiable data packets) from the charging bays 818a-b, through the hub 816-2, to the wireless network device 816-1, via the switch 850b and/or router 850a, and via the network 852 to the server cluster 820. Data such as device usage data (e.g., amount of time used, locations used, tour path or route information, user interaction data), device charge data, software data, firmware data, and/or data descriptive of multimedia tour information stored locally, may for example, be sent or provided to the server cluster 820 periodically (e.g., very evening after the tour location 802 closes for business) and/or may be “pulled” from the charging array 816 in response to a query or request received from the server cluster 820. According to some embodiments, each charging bay 818a-b and/or each charging slot (“A”-“H”) may be uniquely identifiable (e.g., assigned a unique identifier). In some embodiments, charge slot (“A”-“H”) and/or charge bay 818a-b information may be provided to the server cluster 820 with or instead of unique device identifiers. In such a manner, for example, each unique device 808a-b, 810, 812 may be uniquely identifiable and/or addressable by the server cluster 820, e.g., regardless of which slot (“A”-“H”) each device 808a-b, 810, 812a-b is coupled to (i.e., docked in).

According to some embodiments, the server cluster 820 may comprise a first or application server 820a in communication with a first or cache memory 840a and/or a second or Relational Database System (RDS) memory 840b. The application server 820a may, in some embodiments, provide and/or generate an interface 860 on or for the management device 814. According to some embodiments, the interface 860 may comprise a menu bar 862 that allows a user to query or interrogate individual devices 808a-b, 810, 812a-b (e.g., “inspect”), configure individual devices 808a-b, 810, 812a-b or groups of devices 808a-b, 810, 812a-b (e.g., “configure”), allow activation of various device utilities (e.g., battery or charge management; “utilities”), enable firmware management and/or updating (e.g., “firmware”), and/or otherwise manage devices 808a-b, 810, 812a-b, one or more locations 802 and/or one or more charging arrays 816, and/or multimedia content distribution (e.g., “manage”). In some embodiments, the interface 860 may comprise one or more interactive graphical depictions 866a-c of charging arrays 816. The interface 860 may comprise a first graphical depiction 866a, for example, that depicts a fifty rack-unit (50 U) charging array (not itself depicted in FIG. 8) and each charging slot in such array. In some embodiments, the interface 860 may comprise multiple graphical depictions 866b-c of multiple twenty rack-unit (20 U) charging arrays, with a third graphical depiction 866c corresponding to the charging array 816 show in FIG. 8.

In some embodiments, the third graphical depiction 866c may comprise a plurality of device depictions 866c-1, 866c-2, 866c-3, 866c-4, 866c-5, each such device depiction 866c-1, 866c-2, 866c-3, 866c-4, 866c-5 corresponding to one of the devices 808a-b, 810, 812a-b coupled to the respective charging slots “A”, “B”, “F”, “G”, and “H”. According to some embodiments, the device depictions 866c-1, 866c-2, 866c-3, 866c-4, 866c-5 may comprise interactive graphical elements that permit a user to click on or otherwise activate an individual device depiction 866c-1, 866c-2, 866c-3, 866c-4, 866c-5 to directly access and/or interface with the corresponding respective device 808a-b, 810, 812a-b. In such a manner, for example, a user of the management device 814 may view the interface 860, be presented with information (e.g., first information) descriptive of a status of the first proprietary device 808a via, e.g., a color-coding or other output via a first one of the device depictions 866c-1, activate the first one of the device depictions 866c-1 to generate a query regarding the corresponding first proprietary device 808a, and/or receive (e.g., in response to the activation and/or query) more detailed (e.g., second) information descriptive of the first proprietary device 808a. In some embodiments, the information descriptive of the first proprietary device 808a may be stored in either or both of the cache 840a and/or the RDS 840b and/or may be accessed and/or provided by the application server 820a.

According to some embodiments, the server array 820 may comprise a content server 820b that manages multimedia tour content and/or a data processing server 820c that enables data analysis to be conducted on data stored in and/or received from the devices 808a-b, 810, 812a-b. In some embodiments, a separate and/or distinct real-time server 820d may be included in the server array 820 such as to manage real-time queries of status information for the devices 808a-b, 810, 812a-b and/or the charge array 816. In some embodiments, the server array 820 may comprise a maintenance server 820e such as to perform scheduled tasks and/or back-end administrative functions.

In some embodiments, the system 800 and/or the interface 860 may be utilized to dynamically and remotely manage the devices 808a-b, 810, 812a-b. The management device 814 may access the server cluster 820 to retrieve information descriptive of a variety of tour locations 802 and respective charge arrays 816, for example, such as to push a software update to and/or update firmware for any devices 808a-b, 810, 812a-b docked in the selected charge array 816. In some embodiments, such as in the case that the devices 808a-b, 810, 812a-b may comprise mobile electronic platforms having different hardware, firmware, and/or software (e.g., OS) characteristics, a user may utilize the interface 860 to search for and/or filter for any devices 808a-b, 810, 812a-b matching certain criteria (e.g., having a certain OS version and/or a certain firmware version), and may select and push appropriate updates, patches, and/or fixes to a subset of the total number of devices 808a-b, 810, 812a-b currently docked. Similarly, certain devices 808a-b, 810, 812a-b may be selected to receive certain content. Even though all of the devices 808a-b, 810, 812a-b are located at the same tour location 802, for example, the first proprietary device 802a may be selected and loaded with a first version of a multimedia tour, for example, while the second proprietary device 802b may be separately selected and separately loaded with a second version of the multimedia tour. In such a manner, for example, certain subsets or groups of devices 808a-b, 810, 812a-b may be selected, identified, and/o defined, and selectively loaded with certain media, software, updates/drivers, etc.

According to some embodiments, the type of any given device 808a-b, 810, 812a-b may also or alternatively be remotely and dynamically defined and/or changed. Prior to user interaction via the interface 860, for example, the group tour parent device 810 may have been a standard proprietary device 808a-b. It may have been selected via the third individual device depiction 866c-3, however, and commanded to alter setting to become the group tour parent device 810. The group tour parent device 810 may be assigned a certain role, for example, such as a group tour parent, e.g., by setting a role or property to a certain value and/or by activating, enabling, and/or installing certain group tour parent or leader software thereon. In some embodiments, the group tour parent device 810 may be assigned a group identifier and/or a certain value for a language parameter. Similarly, each of the group tour child devices 812a-b may be assigned to the same group as the group tour parent device 810 by setting the group identifier to be the same. In some embodiments, each of the group tour child devices 812a-b may be set to the same language setting for tours that are arranged for a tour guide and tour members that all speak the same language. According to some embodiments, different language settings may be set on the group tour parent device 810, the first group tour child device 812a, and/or the second group tour child device 812b, to arrange the devices 810, 812a-b for a tour in which the tour guide and the tourists speak different languages. In some embodiments, such changes may be easily conducted via the interface 860 may a user selecting each of the third one of the device depictions 866c-3, the fourth one of the device depictions 866c-4, and the fifth one of the device depictions 866c-5 (corresponding to the group tour parent device 810, the first group tour child device 812a, and the second group tour child device 812b, respectively) and then selecting an option (not shown) to assign to the same tour group, language group, etc.

Fewer or more components 802, 808a-b, 810, 812a-b, 814, 816, 816-1, 816-2, 820a-e, 840a-b, 850a-b, 852, 860, 862, 866a-c, 866c-1, 866c-2, 866c-3, 866c-4, 866c-5 and/or various configurations of the depicted components 802, 808a-b, 810, 812a-b, 814, 816, 816-1, 816-2, 820a-e, 840a-b, 850a-b, 852, 860, 862, 866a-c, 866c-1, 866c-2, 866c-3, 866c-4, 866c-5 may be included in the system 800 without deviating from the scope of embodiments described herein. In some embodiments, the components 802, 808a-b, 810, 812a-b, 814, 816, 816-1, 816-2, 820a-e, 840a-b, 850a-b, 852, 860, 862, 866a-c, 866c-1, 866c-2, 866c-3, 866c-4, 866c-5 may be similar in configuration and/or functionality to similarly named and/or numbered components as described herein. In some embodiments, the system 800 (and/or portion thereof) may comprise a multimedia tour (or other data) distribution and/or management program, system, and/or platform programmed and/or otherwise configured to execute, conduct, and/or facilitate the methods 600, 700, 900, 1000, 1200 of FIG. 6, FIG. 7, FIG. 9, FIG. 10, and/or FIG. 12 herein, and/or portions or combinations thereof.

### VIII. Proprietary Device Multimedia Distribution Methods

Turning now to FIG. 9, a flow diagram of a method 900 according to some embodiments is shown. In some embodiments, the method 900 may be performed and/or implemented by and/or otherwise associated with one or more specialized and/or specially-programmed computers (e.g., the controller/server devices 220, 320, 420, 720, 820 of FIG. 2, FIG. 3, FIG. 4, FIG. 7, and/or FIG. 8 herein), specialized computers, computer terminals, computer servers, computer systems and/or networks, and/or any combinations thereof (e.g., by one or more multi-threaded and/or multi-core processing units comprising a server in communication with a charging array at a tour location). In some embodiments, the method 900 may be embodied in, facilitated by, and/or otherwise associated with various input mechanisms and/or interfaces (e.g., the interfaces 360, 560a-i, 860, 1360 of FIG. 3, FIG. 5A, FIG. 5B, FIG. 5C, FIG. 5D, FIG. 5E, FIG. 5F, FIG. 5G, FIG. 5H, FIG. 5I, FIG. 8, and/or FIG. 13 herein).

According to some embodiments, the method 900 may comprise receiving (e.g., via a central controller or server and/or from a remote charging array) an indication of a plurality of unique tour device identifiers corresponding to a plurality of tour devices docked with the charging array, at 902. Various triggering events may, for example, cause any charging arrays in communication with the server to be interrogated to identify which charging bays and/or slots therein are coupled to a mobile electronic tour device. In some embodiments, the interrogation may return a listing of unique device identifiers such as a Media Access Control (MAC) address or identifier or a Universal Unique IDentifier (UUID) and/or a listing of corresponding charging slot/bay identifiers (e.g., a unique code that identifies a particular charging slot, bay, and/or array). In some embodiments, identifiers may be transmitted from the charging array and/or received by the server upon coupling of a new device to a charging slot/bay/array, at predetermined time intervals and/or scheduled times, and/or upon user request via the server. According to some embodiments, other information and/or data descriptive of charging array status may be transmitted and/or received. Upon removal of a device from a charging slot, for example, information may be transmitted updating the listing of docked devices such that the removed device is correspondingly removed from the listing (e.g., maintained by the server). Charging array statistics and/or performance data may also or alternatively be provided, such as electrical throughput data, temperature, total amps and/or volts drawn, network connectivity data, etc.

In some embodiments, the method 900 may comprise identifying (e.g., by the central controller or server), for each docked tour device of the plurality of tour devices, a value of a device characteristic parameter, at 904. Utilizing the corresponding unique tour device identifier and/or unique charge slot identifier for a particular device, for example, the server may query the particular device by sending a specifically-addressed query or data ping via the charging array to which the device is coupled. According to some embodiments, the query may include a request for certain data stored on or by the mobile electronic device that is queried. The query may comprise a request, for example, for proprietary tour device usage data, which may include data descriptive of: (i) an amount of time that the device has been utilized at specific discrete locations (e.g., specific rooms of a building or specific areas of a tour location), (ii) an amount of time that the device has been utilized to play or output particular portions of a multimedia tour, (iii) a record of user input via the device (e.g., requests for help menus or lookups or searches for particular information or features), and/or (iv) device sensor information (e.g., accelerometer data, camera data, temperature data, etc.). In some embodiments, the device characteristic parameter may comprise a charge state or level of the device, other electronic information (e.g., charge rate, resistance, capacitance, etc.), device setting information (e.g., language setting, volume setting, text/font size setting, etc.), and/or device firmware, hardware, and/or software parameters (e.g., firmware type and/or version, hardware type, OS version) such as a version and/or date corresponding to a multimedia tour package installed on the device.

According to some embodiments, the method 900 may comprise identifying (e.g., by the central controller or server) a number of tour devices needed for a particular tour, at 906. The server may determine, based on user input and/or stored data for example, that a particular tour and/or tour group requires a certain number of devices. In the case that a tour is desired to be provided in a certain number of languages for a fixed number of devices at a tour location (e.g., fifty (50) devices in English, one hundred (100) devices in Japanese), for example, a number of required devices may be identified and/or calculated. In the case of specific tour groups such as a known number of school children that are scheduled to arrive at a tour location, a number of primary or parent devices may be identified based on a number of chaperones and/or a number of secondary or child devices may be identified based on a number of school children. According to some embodiments, numbers and/or quantities for special considerations may be identified. In the case that three (3) of the school children are known to have learning disabilities, for example, it may be determined that three (3) devices are required to be specially programmed and/or to be loaded with a special version of multimedia content tailored to the disabilities. Similarly, a number of devices required for any specific language, impairment, and/or special preference (e.g., a preference directed to more historical aspects or a preference directed to architecture, military, or other custom tour features or genres) may be identified. According to some embodiments, any number, type (e.g., enhanced audio, haptic interface capability), and/or configuration of desired or required devices may be received from a user such as via a user interface for managing tour devices (e.g., the interface 860 of FIG. 8).

In some embodiments, the method 900 may comprise selecting (e.g., by the central controller or server) a subset of the plurality of tour devices, the subset being equal to the number of tour devices needed for the particular tour, at 908. In the case that one hundred (100) tour devices are docked in one or more charging arrays at a tour location, for example, and only thirty (30) devices are needed for a particular tour and/or tour group, thirty (30) of the one hundred (100) devices may be selected for the particular tour. According to some embodiments, the subset of devices may be selected from the plurality of available tour devices based on the values of the device characteristic parameters (e.g., identified at 904). In the case that thirty (30) of the one hundred (100) available devices are needed, for example, thirty (30) of the one hundred (100) devices may be selected based on a ranking (and/or filtering) of one or more characteristic parameter values, e.g., the top thirty (30) with the highest or lowest parameter value ranking may be selected for the subset. According to some embodiments, the devices having the highest charge level, the latest OS version, particular hardware capabilities (e.g., location tracking, such as to keep track of school children), and/or particular installed software, may be selected. In the case that ranking criteria provides more qualified devices than are necessary, devices for the subset may be chosen randomly from the ranking and/or filtering results. According to some embodiments, the subset may also or alternatively be selected based on charge slot identifications and/or locations—e.g., thirty (30) of the one hundred (100) tour devices that are adjacent, proximate, and/or docked in the same charging array and/or bay thereof may, for example, be selected to speed distribution of the devices to tour group members.

In some embodiments, the method 900 may comprise transmitting (e.g., from the central controller or server and to a charging array) a first multimedia tour package, at 910. The first multimedia tour package may be downloaded to each of the tour devices of the subset of the plurality of tour devices, for example. According to some embodiments the transmitting/downloading may be conducted utilizing the corresponding unique tour device identifiers and/or charge slot identifiers. Packets of information defining the first multimedia tour package may be specifically addressed, for example, to one or more uniquely addressable electronic device locations on the network, such as a particular mobile electronic tour device coupled (e.g., docked) to a particular charge slot in a particular charge bay of a particular charging array at a specific tour location. In some embodiments, the first multimedia tour package may comprise a subset of multimedia tour data stored at or by the server. A specific version (e.g., in a first language, or having content tailored to a specific demographic group) of a multimedia tour may be selected as the first multimedia tour package, for example, and downloaded to the specific subset of devices. Similarly, the method 900 may comprise identifying a second subset of devices (e.g., for a second or different particular tour) and transmitting and/or downloading a second multimedia tour package to the second subset of devices. In such a manner, for example, large numbers of electronic tour devices may be dynamically and selectively managed to customize proprietary device content and/or usage for any particular tour location. In some embodiments, the first multimedia tour package may comprise values for various settings and/or preferences. One or more devices may be commanded via certain scripts, values, and/or triggers embedded with and/or included as part of the first multimedia tour package, for example, to be reconfigured as parent group tour devices or child group tour devices. The first multimedia tour package may include, for example, a group tour code and/or identifier that links the subset of devices together communicatively.

Referring now to FIG. 10, a flow diagram of a systemic method 1000 according to some embodiments, is shown. The method 1000 may, for example, be executed by various hardware and/or logical components via interactive communications, such as may involve communications between a charging array 1016 (comprising and/or defining a first charging bay 1018a having a first charging slot “A” and/or a second charging bay 1018b having a second charging slot “B” and/or a third charging slot “C”), a server 1020, and/or a database 1040. In some embodiments, the charging array 1016 may comprise a network device 1050 for remote and/or wireless communications with the server 1020. In some embodiments, a mobile electronic tour device (not separately depicted or labeled) may be coupled to and/or docked with each of the charging slots “A”, “B”, and “C”. While not explicitly depicted in FIG. 1000, the devices and/or components 1016, 1018a-b, 1020, 1040, 1050 may be in communication via various networks and/or network components, and/or may process received data by executing instructions via one or more electronic processing devices.

In some embodiments, the method 1000 (e.g., for selectively distributing subsets and/or portions of multimedia tour data to selected subsets of proprietary tour devices) may begin at “1” with an identifier of the first device and/or the first slot “A” being provided to the network device 1050. In some embodiments, the identifier(s) may be provided on a scheduled and/or time-triggered basis or may be provided in response to an interrogation, query, and/or polling (not depicted in FIG. 10). Similarly, the method 1000 may comprise an identifier of the second device and/or the second slot “B” being provided to the network device 1050, at “2”, and/or an identifier of the third device and/or the third slot “C” being provided to the network device 1050, at “3”. According to some embodiments, the network device 1050 may forward and/or transmit the various identifiers (and/or other associated information) to the server 1020, at “4”. In some embodiments, the server 1020 may receive the identifiers and then may identify and/or compute (e.g., utilizing stored rules and/or logic) one or more mobile device characteristic parameters for which values are desired, at “5”. The server 1020 may identify, for example, that charge levels or OS versions for the devices are necessary for a particular operation and/or to respond to a particular request (not depicted in FIG. 10).

According to some embodiments, the server 1020 may transmit a request, command, and/or query for the desired device characteristic parameter values to the network device 1050 (e.g., to the charge array 1016), at “6”. In some embodiments, the request for parameter values may be specifically addressed to each specific device, slot (“A”, “B”, “C”, “D”), and/or charge bay 1018a-b, e.g., utilizing the received identifiers. According to some embodiments, the request may be forward to the first slot “A” (and attendant first device) at “7”, to the second slot “B” (and attendant second device) at “8”, and/or to the third slot “C” (and attendant third device) at “9”. In some embodiments, the request may comprise multiple differing and/or customized requests. The request to the first slot “A”, for example, may comprise a request for OS version data, while the request to the third slot “C” may comprise a request for usage history data.

In some embodiments, the first device and/or slot “A” may locate the queried data (e.g., in a mobile memory device of the first device) at “10” and provide the data (e.g., in response to the request) to the network device 1050, at “11”. According to some embodiments, the second device and/or slot “B” may locate the queried data (e.g., in a mobile memory device of the second device) at “12” and provide the data (e.g., in response to the request) to the network device 1050, at “13”. In some embodiments, the third device and/or slot “C” may locate the queried data (e.g., in a mobile memory device of the third device) at “14” and provide the data (e.g., in response to the request) to the network device 1050, at “15”. Any or all response data (e.g., the values for the requested mobile device characteristic parameters) may then, for example, be forwarded by the network device 1050 to the server 1020, at “16”. According to some embodiments, the server 1020 may process, store, and/or rank or score the received characteristic values, at “17”. The server 1020 may, in the case that the requested parameter values comprise charge levels for each of the three (3) devices/slots (“A”, “B”, “C”), for example, rank the three (3) devices/slots (“A”, “B”, “C”) according to the received charge level values—e.g., highest to lowest, such that the device with the most charge is ranked first.

According to some embodiments, the server 1020 may send the received values and/or rankings to the database 1040, at “18”. In some embodiments, the server 1020 may also or alternatively query the database 1040 at “18”. The server 1020 may, for example, send a query to the database 1040 to retrieve details defining a number, type, and/or configuration of mobile tour devices needed for a particular tour. Such information may be stored in the database 1040 and/or may be provided, input, and/or received from a user (not shown), e.g., from an interface configured to manage proprietary tour devices (also not shown in FIG. 10). In some embodiments, the database 1040 may process the request/query and identify the desired information descriptive of the requirements for the particular tour, at “19”. The database 1040 may then, for example, forward the results (e.g., in response to the query) to the server 1020, at “20”. According to some embodiments, the database 1040 may provide various multimedia tour content to the server 1020 at “20”.

In some embodiments, the server 1020 may utilize the information descriptive of the requirements for the particular tour and the information descriptive of the values for the device characteristic parameters to identify a subset of the devices to which certain data and/or commands should be sent, at “21”. Applying stored rules and/or logic, for example, the server 1020 may calculate that two (2) devices are needed for a particular tour that must be conducted in Spanish. The server 1020 may analyze the device characteristic values to identify that the second and third devices are already programmed for and/or set to Spanish and may accordingly select those devices as the subset of available devices. As another non-limiting example, the server 1020 may determine that one (1) device is required to be a tour guide device and may identify the first device as a device that includes the necessary hardware, permissions, software, etc. that are appropriate for a group tour parent device and may accordingly select that device as the subset. In the non-limiting example depicted in FIG. 10, the server 1020 may determine that the third device has the highest charge level of all the available devices and may accordingly select the third device as the subset of the available devices.

According to some embodiments, the server 1020 may transmit a specifically selected command, parameter setting, portion of multimedia content, and/or multimedia content package to the charge array 1016 via the network device 1050, at “22”. The content may, in some embodiments, be specifically addressed to a first subset of the devices, such as the third device in the third slot “C”. According to some embodiments, the network device 1050 may forward, route, and/or direct the content to the appropriate subset of devices (e.g., the third device/slot “C”, as depicted), at “23”. In some embodiments, different commands, settings, parameter values, and/or content packages may be transmitted by the server 1020 to the network device 1050, at “24”. A second multimedia tour package received by the network device 1050 at “24” may, for example, be specifically addressed to the first device/slot “A” and may be routed thereto, at “25”. In such a manner, for example, different proprietary mobile tour devices may be loaded with different content and/or adjusted to particular settings, individually or in groups, to customize arrays of devices for specific tour locations and/or tour groups.

While many specific actions of the method 1000 have been described with respect to FIG. 10, fewer or more actions, transmissions, and/or processing procedures may be implemented in the method 1000 without deviating from embodiments herein. In some embodiments, fewer or more components 1016, 1018a-b, 1020, 1040, 1050 and/or various configurations of the depicted components 1016, 1018a-b, 1020, 1040, 1050 may be included in the method 1000 without deviating from the scope of embodiments described herein. In some embodiments, the components 1016, 1018a-b, 1020, 1040, 1050 may be similar in configuration and/or functionality to similarly named and/or numbered components as described herein. In some embodiments, the method 1000 (and/or one or more portions thereof) may comprise a multimedia tour (or other data) distribution and/or management program, system, and/or platform programmed and/or otherwise configured to execute, conduct, and/or facilitate the other methods 600, 700, 900, 1200 of FIG. 6, FIG. 7, FIG. 9, and/or FIG. 12 herein, and/or portions or combinations thereof.

### IX. Device-Guided Tour Mesh Network Systems

Referring now to FIG. 11, a block diagram of a system 1100 according to some embodiments is shown. In some embodiments, the system 1100 may comprise a multimedia data distribution system similar to the systems 200, 300, 400, 800 of FIG. 2, FIG. 3, FIG. 4, and/or FIG. 8 herein, and/or portions thereof. According to some embodiments, the system 1100 may comprise a system for facilitating mesh-network communication and/or sharing of multimedia tour content in a group tour environment. The system 1100 may comprise, for example, a tour location 1102 in which a plurality of individuals 1106a-g are disposed. In the non-limiting example depicted in FIG. 11, a first one of the individuals 1106a may comprise a group tour guide or leader utilizing a group tour parent device 1110. The group tour guide 1106a may, for example, be employed by the tour location 1102 and/or otherwise comprise a leader of a specific tour of the tour location 1102. In some embodiments, each of a second individual 1106b or first tourist (utilizing a second group tour child device 1112b or first tourist device), a third individual 1106c or second tourist (utilizing a third group tour child device 1112c or second tourist device), a fourth individual 1106d or third tourist (utilizing a fourth group tour child device 1112d or third tourist device), a fifth individual 1106e or fourth tourist (utilizing a fifth group tour child device 1112e or fourth tourist device), and/or a sixth individual 1106f or fifth tourist (utilizing a sixth group tour child device 1112f or fifth tourist device), may belong to the same tour group and/or may be led by the group tour guide 1106a.

According to some embodiments (as depicted in FIG. 11), the group tour parent device 1110 may have a transmission range “A”, in which the first tourist device 1112b, the second tourist device 1112c, the third tourist device 1112d, and the fourth tourist device 1112e are located. This in-range devices 1112b-e may, for example, be properly positioned to receive audio, alerts/messages, and/or multimedia transmissions from the group tour parent device 1110, e.g., at the selective activation of the group tour guide 1106a. In some embodiments, the fifth tourist 1106f may be positioned outside of the effective range “A” of the group tour parent device 1110 and the fifth tourist device 1112f may accordingly not be capable of receiving transmissions from the group tour parent device 1110. As depicted in FIG. 11, in some embodiments the second tourist 1106c may utilize the second tourist device 1112c which comprises a transmission capability having an effective range “B”.

In some embodiments, the fifth tourist device 1112f may detect a loss of transmission from the group tour parent device 1110 and may actively search for available signals that include a particular identifier for the specific group tour. In the case that the second tourist device 1112c broadcasts a signal in the range “B” that includes an identifier of the tour group (e.g., a unique, encoded, and/or encrypted identifier), for example, the fifth tourist device 1112f may detect the signal and identify the group code. Upon such an identification, the fifth tourist device 1112f may connect to the second tourist device 1112c and request or otherwise receive a re-broadcast or re-transmission of any content originating from the group tour parent device 1110. In such a manner, for example, group tour members 1106b-f may be permitted to stray farther from the group tour guide 1106a than in typical systems, which in turn permits the group tour guide 1106a, for example, to use a lower speaking voice, which may be more appropriate and/or less disruptive for certain tour locations 1102. Utilizing such a dynamic meshing of communications between the devices 1110, 1112a-f may also, for example, permit larger tour groups than are typically practicable, which may increase profitability of the tour location 1102.

According to some embodiments, a seventh individual 1106g or sixth tourist may utilize a self-owned or non-proprietary device 1114 to receive multimedia tour content as described herein. The non-proprietary device 1114 may, for example, receive a language setting-based subset of available multimedia tour content from a DDP device (not shown) as described herein. In some embodiments, the non-proprietary device 1114 may also or alternatively join the group tour and/or receive content associated with the group tour. The non-proprietary device 1114 may, for example, identify a transmission from the fifth tourist device 1112f within a transmission range “C” and/or other transmissions (not shown) and provide a listing of available group tours to the sixth tourist 1106g. Even in the case that the sixth tourist 1106g and/or non-proprietary device 1114 are located behind an obstruction “D”, outside of a line-of-sight from the group tour parent device 1110, and/or otherwise distant therefrom, for example, the sixth tourist 1106g may be provided with the opportunity to join the group tour. To access the group tour, the sixth tourist 1106g may be required to enter an access code (e.g., from a purchased ticket for the tour location 1102) and/or payment identifier via the non-proprietary device 1114. In such a manner, for example, even the sixth tourist 1106g, whom is not originally part of the group tour, may selectively and dynamically join the group tour. Similarly, even in the case that the fifth tourist device 1112f is out of range from the group tour parent device 1110 and is yet able to receive group tour content therefrom via the second tourist device 1112c, such content may be further relayed and/or distributed to the non-proprietary device 1114 via the sixth tourist 1106g.

Fewer or more components 1102, 1106a-g, 1110, 1112b-f, 1114 and/or various configurations of the depicted components 1102, 1106a-g, 1110, 1112b-f, 1114 may be included in the system 1100 without deviating from the scope of embodiments described herein. In some embodiments, the components 1102, 1106a-g, 1110, 1112b-f, 1114 may be similar in configuration and/or functionality to similarly named and/or numbered components as described herein. In some embodiments, the system 1100 (and/or portion thereof) may comprise a multimedia tour (or other data) distribution and/or management program, system, and/or platform programmed and/or otherwise configured to execute, conduct, and/or facilitate the methods 600, 700, 900, 1000, 1200 of FIG. 6, FIG. 7, FIG. 9, FIG. 10, and/or FIG. 12 herein, and/or portions or combinations thereof.

### X. Device-Guided Tour Mesh Network Methods

Turning now to FIG. 12, a flow diagram of a method 1200 according to some embodiments is shown. In some embodiments, the method 1200 may be performed and/or implemented by and/or otherwise associated with one or more specialized and/or specially-programmed computers (e.g., the controller/server devices 220, 320, 420, 720, 820 and/or the various user devices 208a-b, 210, 212, 214a-n, 314, 414, 514, 714, 814, 1110, 1112a-f, 1114 of FIG. 2, FIG. 3, FIG. 4, FIG. 5, FIG. 7, FIG. 8, and/or FIG. 11 herein), specialized computers, computer terminals, computer servers, computer systems and/or networks, and/or any combinations thereof (e.g., by one or more multi-threaded and/or multi-core processing units comprising a server in communication with a charging array at a tour location). In some embodiments, the method 1200 may be embodied in, facilitated by, and/or otherwise associated with various input mechanisms and/or interfaces (e.g., the interfaces 360, 560a-i, 860, 1360 of FIG. 3, FIG. 5A, FIG. 5B, FIG. 5C, FIG. 5D, FIG. 5E, FIG. 5F, FIG. 5G, FIG. 5H, FIG. 5I, FIG. 8, and/or FIG. 13 herein).

According to some embodiments, the method 1200 may comprise broadcasting (e.g., by a group tour parent device) tour information, at 1202. Tour information such as a group tour identifier, tour guide audio, tour instructions (e.g., a request to keep voices down, not to touch objects, and/or navigational instructions), and/or multimedia tour data (e.g., images, videos, etc.), may, for example, be broadcast by a mobile tour device. In some embodiments, such as in the case that the group tour parent device is communicatively “paired” to one or more group tour child devices (e.g., utilizing Bluetooth® or another short-range communication protocol), the broadcast may comprise a transmission designated for such paired devices. In some embodiments, the broadcasting may comprise a transmission of a group tour identifier. The group tour identifier may comprise an alphanumeric sequence, coded data, and/or encrypted data, for example, that uniquely identifies a particular group tour, tour guide, and/or tourist group (e.g., a particular elementary school).

In some embodiments, the method 1200 may comprise receiving (e.g., by a first group tour child device and/or from the group tour parent device) the tour information, at 1204. A first group tour child device within an operational range of the broadcasting or transmission of the group tour parent device may, for example, detect, identify, and/or receive the broadcast/transmitted tour information (e.g., via a wireless receiver or transceiver device thereof). According to some embodiments, the first group tour device may compare a stored group and/or group tour identifier to an identifier provided with or as part of the broadcast/transmitted tour information. In the case that the stored identifier does not match the received identifier, the first group tour child device may ignore or discard the received tour information (e.g., the received signal may trigger not further action by the first group tour child device). In the case that the stored identifier does match the received identifier, the first group tour child device may proceed and/or the method 1200 may continue.

According to some embodiments, for example, the method 1200 may comprise decoding (e.g., by the first group tour child device) the tour information, at 1206. The group tour identifier and/or other tour information such as a multimedia tour package may be encoded and/or encrypted, for example, and a processing unit of the first group tour child device may accordingly execute one or more decoding and/or decryption algorithms to decode and/or decrypt the tour information. In some embodiments, the tour information may only be capable of being decoded and/or decrypted in the case that the first group tour child devices stores and/or has access to an appropriate algorithm and/or key. According to some embodiments, the appropriate algorithm and/or key may be downloaded to the first group tour child device during a pairing procedure with the group tour parent device and/or may be accessed by purchase of a tour ticket and/or authorization of a payment identifier.

In some embodiments, the method 1200 may comprise outputting (e.g., by the first group tour child device) the tour information, at 1208. The first group tour child device may comprise a display device and/or a speaker (and/or audio jack) via which the tour information (e.g., decoded and/or decrypted tour information) may be output to a user (e.g., a tourist and/or tour group member). In some embodiments, the tour information may be output in a format structured in accordance with one or more settings of the first group tour child device. In the case that the first group tour child device is set to a particular language, for example, the tour information (e.g., spoken and/or written portions thereof) may be output in the appropriate corresponding language). In some embodiments, one or more commands and/or setting values may be received with and/or as part of the tour information and may be utilized by the first group tour child device to output the tour information in a particular manner (e.g., a certain volume, brightness setting, etc.).

According to some embodiments, the method 1200 may comprise broadcasting (e.g., by the first group tour child device) tour information, at 1210. In some embodiments, the broadcasting may comprise a re-broadcasting or re-transmitting or “repeating” (e.g., similar to a radio frequency repeater station) of the tour information received from the group tour parent device. Tour information such as a group tour identifier, tour guide audio, tour instructions (e.g., a request to keep voices down, not to touch objects, and/or navigational instructions), and/or multimedia tour data (e.g., images, videos, etc.), may, for example, be broadcast (or re-broadcast) by a mobile group tour child device. In some embodiments, such as in the case that the first group tour child device is communicatively “paired” to one or more other group tour child devices (e.g., utilizing Bluetooth® or another short-range communication protocol), the broadcast may comprise a transmission designated for such paired devices. In some embodiments, the broadcasting may comprise a transmission of a group tour identifier. The group tour identifier may comprise an alphanumeric sequence, coded data, and/or encrypted data, for example, that uniquely identifies a particular group tour, tour guide, and/or tourist group (e.g., a particular elementary school). In some embodiments, the tour information may be received (e.g., at 1204) via a first wireless network such as Wi-Fi® and the broadcasting/re-broadcasting at 1210 may be conducted via a second network such as via a Bluetooth®, IR, RF, and/or NFC wireless network. In some embodiments, the broadcasting from the first group tour child device may comprise or be referred to as a “group tour extension broadcast” (e.g., as it may extend the range of wireless coverage for the group tour).

In some embodiments, the method 1200 may comprise identifying (e.g., by a second group tour child device) the group tour extension broadcast, at 1212. A second group tour child device within an operational range of the broadcasting or transmission of the first group tour child device may, for example, detect the group tour extension broadcast as an available wireless network. According to some embodiments, the identifying may comprise comparing a stored group and/or group tour identifier to an identifier provided with or as part of the re-broadcast/re-transmitted tour information. In the case that the stored identifier does not match the received identifier, the second group tour child device may ignore or discard the received tour information (e.g., the received signal may trigger not further action by the second group tour child device). In the case that the stored identifier does match the received identifier, the second group tour child device may proceed and/or the method 1200 may continue. According to some embodiments, the identifying of the group tour extension broadcast may occur in response to an identifying of a loss of signal from the group tour parent device.

In some embodiments, for example, the method 1200 may comprise receiving (e.g., by the second group tour child device and/or from the first group tour child device) the tour information, at 1212. The second group tour child device, after identifying the group tour extension broadcast from the first group tour child device for example, may download and/or otherwise intake the tour information provided by the first group tour child device.

According to some embodiments, the method 1200 may comprise decoding (e.g., by the second group tour child device) the tour information, at 1216. The group tour identifier and/or other tour information such as a multimedia tour package may be encoded and/or encrypted, for example, and a processing unit of the second group tour child device may accordingly execute one or more decoding and/or decryption algorithms to decode and/or decrypt the tour information. In some embodiments, the tour information may only be capable of being decoded and/or decrypted in the case that the second group tour child devices stores and/or has access to an appropriate algorithm and/or key. According to some embodiments, the appropriate algorithm and/or key may be downloaded to the second group tour child device during a pairing procedure with the group tour parent device and/or with the first group tour child device and/or may be accessed by purchase of a tour ticket and/or authorization of a payment identifier.

In some embodiments, the method 1200 may comprise outputting (e.g., by the second group tour child device) the tour information, at 1218. The second group tour child device may comprise a display device and/or a speaker (and/or audio jack) via which the tour information (e.g., decoded and/or decrypted tour information) may be output to a user (e.g., a tourist and/or tour group member). In some embodiments, the tour information may be output in a format structured in accordance with one or more settings of the second group tour child device. In the case that the second group tour child device is set to a particular language, for example, the tour information (e.g., spoken and/or written portions thereof) may be output in the appropriate corresponding language). In some embodiments, one or more commands and/or setting values may be received with and/or as part of the tour information and may be utilized by the second group tour child device to output the tour information in a particular manner (e.g., a certain volume, brightness setting, etc.). In such a manner, for example, the second group tour child device may provide group tour content to a tourist even though the tourist/second group tour child device is outside of a broadcast/transmission and/or communication range of the group tour parent device. In some embodiments, a loss of signal that may cause the chaining of the first and second group tour child devices may occur not because the second group tour child device is too far distant from the group tour parent device, but because the signal from the group tour parent device is otherwise impeded (e.g., due to obstacles and/or interference).

### XI. Multimedia Distribution Apparatus and Articles of Manufacture

Turning to FIG. 13, a block diagram of an apparatus 1330 according to some embodiments is shown. In some embodiments, the apparatus 1330 may be similar in configuration and/or functionality to any of the DDP devices 230, 330, 430, 730, the controller/server devices 220, 320, 420, 720, 820a-e, 1020, and/or the user/mobile devices 208a-b, 210, 212, 214a-n, 314, 414, 514, 714, 808a-b, 810, 812a-b, 814, 1110, 1112a-f, 1114 of FIG. 2, FIG. 3, FIG. 4, FIG. 5A, FIG. 5B, FIG. 5C, FIG. 5D, FIG. 5E. FIG. 5F, FIG. 5G, FIG. 5H, FIG. 5I, FIG. 7, FIG. 8, FIG. 10, and/or FIG. 11 herein. The apparatus 1330 may, for example, execute, process, facilitate, and/or otherwise be associated with the methods 600, 700, 900, 1000, 1200 of FIG. 6, FIG. 7, FIG. 9, FIG. 10, and/or FIG. 12 herein, and/or portions or combinations thereof. In some embodiments, the apparatus 1330 may comprise a processing device 1332, a communication device 1334, an input device 1336a, an output device 1336b, a cooling device 1338, a memory device 1340 (storing various programs and/or instructions 1342 and data 1344), and/or an interface 1360. According to some embodiments, any or all of the components 1332, 1334, 1336a-b, 1338, 1340, 1342, 1344, 1360 of the apparatus 1330 may be similar in configuration and/or functionality to any similarly named and/or numbered components described herein. Fewer or more components 1332, 1334, 1336a-b, 1338, 1340, 1342, 1344, 1360 and/or various configurations of the components 1332, 1334, 1336a-b, 1338, 1340, 1342, 1344, 1360 be included in the apparatus 1330 without deviating from the scope of embodiments described herein.

According to some embodiments, the processor 1332 may be or include any type, quantity, and/or configuration of processor that is or becomes known. The processor 1332 may comprise, for example, an Intel® IXP 2800 network processor or an Intel® XEON™ Processor coupled with an Intel® E7501 chipset. In some embodiments, the processor 1332 may comprise multiple inter-connected processors, microprocessors, and/or micro-engines. According to some embodiments, the processor 1332 (and/or the apparatus 1330 and/or other components thereof) may be supplied power via a power supply (not shown) such as a battery, an Alternating Current (AC) source, a Direct Current (DC) source, an AC/DC adapter, solar cells, and/or an inertial generator. In the case that the apparatus 1330 comprises a server such as a blade server, necessary power may be supplied via a standard AC outlet, power strip, surge protector, and/or Uninterruptible Power Supply (UPS) device.

In some embodiments, the communication device 1334 may comprise any type or configuration of communication device that is or becomes known or practicable. The communication device 1334 may, for example, comprise a Network Interface Card (N IC), a telephonic device, a cellular network device, a router, a hub, a modem, and/or a communications port or cable. In some embodiments, the communication device 1334 may be coupled to retrieve setting information from a user's wireless device (not separately depicted), such as in the case that the apparatus 1330 is utilized to acquire language setting data and utilize such data to automatically filter, select, identify, and/or define a subset of available content for localized wireless dissemination. The communication device 1334 may, for example, comprise a BLE and/or RF transceiver device that is communicatively coupled to deliver (and/or receive) automatically filtered multimedia data. According to some embodiments, the communication device 1334 may also or alternatively be coupled to the processor 1332. In some embodiments, the communication device 1334 may comprise an IR, RF, Bluetooth™, Near-Field Communication (NFC), and/or Wi-Fi® network device coupled to facilitate communications between the processor 1332 and another device (such as a user device and/or remote server device, not separately shown in FIG. 13).

In some embodiments, the input device 1336a and/or the output device 1336b are communicatively coupled to the processor 1332 (e.g., via wired and/or wireless connections and/or pathways) and they may generally comprise any types or configurations of input and output components and/or devices that are or become known, respectively. The input device 1336a may comprise, for example, a keyboard that allows an operator of the apparatus 1330 to interface with the apparatus 1330 (e.g., by an administrator, such as to define multimedia tour data, as described herein). In some embodiments, the input device 1336a may comprise a sensor such as a receiver configured to provide information such as wireless beacon identifiers, to the apparatus 1330 and/or the processor 1332. The output device 1336b may, according to some embodiments, comprise a display screen and/or other practicable output component and/or device. The output device 1336b may, for example, provide an interface 1360 (such as the interfaces 260, 560a-i, 860 of FIG. 2, FIG. 5A, FIG. 5B, FIG. 5C, FIG. 5D, FIG. 5E. FIG. 5F, FIG. 5G, FIG. 5H, FIG. 5I, and/or FIG. 8 herein) via which automatically filtered subsets of stored multimedia content may be disseminated via a short-range wireless network, as described herein. According to some embodiments, the input device 1336a and/or the output device 1336b may comprise and/or be embodied in a single device such as a touch-screen monitor.

According to some embodiments, the apparatus 1330 may comprise the cooling device 1338. According to some embodiments, the cooling device 1338 may be coupled (physically, thermally, and/or electrically) to the processor 1332 and/or to the memory device 1340. The cooling device 1338 may, for example, comprise a fan, heat sink, heat pipe, radiator, cold plate, and/or other cooling component or device or combinations thereof, configured to remove heat from portions or components of the apparatus 1330.

The memory device 1340 may comprise any appropriate information storage device that is or becomes known or available, including, but not limited to, units and/or combinations of magnetic storage devices (e.g., a hard disk drive), optical storage devices, and/or semiconductor memory devices such as RAM devices, Read Only Memory (ROM) devices, Single Data Rate Random Access Memory (SDR-RAM), Double Data Rate Random Access Memory (DDR-RAM), and/or Programmable Read Only Memory (PROM). The memory device 1340 may, according to some embodiments, store one or more of progressive web app instructions 1342-1, interface instructions 1342-2, multimedia tour (and/or other) data 1344-1, and/or device data 1344-2. In some embodiments, the progressive web app instructions 1342-1, interface instructions 1342-2, multimedia tour data 1344-1, and/or device data 1344-2 may be utilized by the processor 1332 to provide output information via the output device 1336b and/or the communication device 1334.

According to some embodiments, the progressive web app instructions 1342-1 may be operable to cause the processor 1332 to process the multimedia tour data 1344-1 and/or device data 1344-2 in accordance with embodiments as described herein. Multimedia tour data 1344-1 and/or device data 1344-2 received via the input device 1314 and/or the communication device 1334 may, for example, be analyzed, sorted, filtered, decoded, decompressed, ranked, scored, plotted, and/or otherwise processed by the processor 1332 in accordance with the progressive web app instructions 1342-1. In some embodiments, multimedia tour data 1344-1 and/or device data 1344-2 may be fed by the processor 1312 through one or more mathematical and/or statistical formulas and/or models in accordance with the progressive web app instructions 1342-1 to provide automatically filtered and/or selected multimedia content subsets for localized mobile device download, as described herein.

In some embodiments, the interface instructions 1342-4 may be operable to cause the processor 1312 to process the multimedia tour data 1344-1 and/or device data 1344-2 in accordance with embodiments as described herein. Multimedia tour data 1344-1 and/or device data 1344-2 received via the input device 1314 and/or the communication device 1334 may, for example, be analyzed, sorted, filtered, decoded, decompressed, ranked, scored, plotted, and/or otherwise processed by the processor 1332 in accordance with the interface instructions 1342-4. In some embodiments, multimedia tour data 1344-1 and/or device data 1344-2 may be fed by the processor 1332 through one or more mathematical and/or statistical formulas and/or models in accordance with the interface instructions 1342-4 to provide the interface 1360 (such as the interfaces 260, 560a-i, 860 of FIG. 2, FIG. 5A, FIG. 5B, FIG. 5C, FIG. 5D, FIG. 5E. FIG. 5F, FIG. 5G, FIG. 5H, FIG. 5I, and/or FIG. 8 herein) via which input and/or output descriptive of multimedia data for localized mobile device dissemination may be provided, as described herein.

Any or all of the exemplary instructions and data types described herein and other practicable types of data may be stored in any number, type, and/or configuration of memory devices that is or becomes known. The memory device 1340 may, for example, comprise one or more data tables or files, databases, table spaces, registers, and/or other storage structures. In some embodiments, multiple databases and/or storage structures (and/or multiple memory devices 1340) may be utilized to store information associated with the apparatus 1330. According to some embodiments, the memory device 1340 may be incorporated into and/or otherwise coupled to the apparatus 1330 (e.g., as shown) or may simply be accessible to the apparatus 1330 (e.g., externally located and/or situated).

Referring to FIG. 14A, FIG. 14B, FIG. 14C, FIG. 14D, and FIG. 14E, perspective diagrams of exemplary data storage devices 1440a-e according to some embodiments are shown. The data storage devices 1440a-e may, for example, be utilized to store instructions and/or data such as the progressive web app instructions 1342-1, interface instructions 1342-2, multimedia tour data 1344-1, and/or device data 1344-2, each of which is presented in reference to FIG. 13 herein. In some embodiments, instructions stored on the data storage devices 1440a-e may, when executed by a processor, cause the implementation of and/or facilitate the methods 600, 700, 900, 1000, 1200 of FIG. 6, FIG. 7, FIG. 9, FIG. 10, and/or FIG. 12 herein, and/or portions or combinations thereof.

According to some embodiments, the first data storage device 1440a-e may comprise one or more various types of internal and/or external hard drives. The first data storage device 1440a may, for example, comprise a data storage medium 1446 that is read, interrogated, and/or otherwise communicatively coupled to and/or via a disk reading device 1448. In some embodiments, the first data storage device 1440a and/or the data storage medium 1446 may be configured to store information utilizing one or more magnetic, inductive, and/or optical means (e.g., magnetic, inductive, and/or optical-encoding). The data storage medium 1446, depicted as a first data storage medium 1446a for example (e.g., breakout cross-section “A”), may comprise one or more of a polymer layer 1446a-1, a magnetic data storage layer 1446a-2, a non-magnetic layer 1446a-3, a magnetic base layer 1446a-4, a contact layer 1446a-5, and/or a substrate layer 1446a-6. According to some embodiments, a magnetic read head 1448a may be coupled and/or disposed to read data from the magnetic data storage layer 1446a-2.

In some embodiments, the data storage medium 1446, depicted as a second data storage medium 1446b for example (e.g., breakout cross-section “B”), may comprise a plurality of data points 1446b-2 disposed with the second data storage medium 1446b. The data points 1446b-2 may, in some embodiments, be read and/or otherwise interfaced with via a laser-enabled read head 1448b disposed and/or coupled to direct a laser beam through the second data storage medium 1446b.

In some embodiments, the second data storage device 1440b may comprise a CD, CD-ROM, DVD, Blu-Ray™ Disc, and/or other type of optically-encoded disk and/or other storage medium that is or becomes know or practicable. In some embodiments, the third data storage device 1440c may comprise a USB keyfob, dongle, and/or other type of flash memory data storage device that is or becomes know or practicable. In some embodiments, the fourth data storage device 1440d may comprise RAM of any type, quantity, and/or configuration that is or becomes practicable and/or desirable. In some embodiments, the fourth data storage device 1440d may comprise an off-chip cache such as a Level 2 (L2) cache memory device. According to some embodiments, the fifth data storage device 1440e may comprise an on-chip memory device such as a Level 1 (L1) cache memory device.

The data storage devices 1440a-e may generally store program instructions, code, and/or modules that, when executed by a processing device cause a particular machine to function in accordance with one or more embodiments described herein. The data storage devices 1440a-e depicted in FIG. 14A, FIG. 14B, FIG. 14C, FIG. 14D, and FIG. 14E are representative of a class and/or subset of computer-readable media that are defined herein as “computer-readable memory” (e.g., non-transitory memory devices as opposed to transmission devices or media).

### XII. Additional Embodiments

In some embodiments, a multimedia distribution system may comprise a Mobile Device Management (MDM) system that remotely manages proprietary mobile device charging, configuration, and/or updating (and/or upgrading). The MDM system may comprise, for example, a centralized computer server that is accessible via a webpage and/or proprietary client-side application and may provide interfaces generated to permit a user to build and/or customize multimedia content packages such as multimedia tours. A “tour builder” webpage and/or client-side application (e.g., served, executed, and/or provided by the server) may, for example, provide a GUI via which a user (e.g., a tour operator and/or tour location client) may easily prepare any number of linear and/or random-access (e.g., room-level awareness and/or object-level awareness) multimedia tour programs/content. In some embodiments, the GUI may permit building and/or defining of one or more PWA modules and/or components that may be utilized to proactively disseminate tour components to user device in the field. In some embodiments, the multimedia tour package created via the GUI may be stored as an open-standard file format such as a JavaScript Object Notation (JSON) file in accordance with the RFC 7159 standard published by the Internet Engineering Task Force (IETF®) in March 2014. According to some embodiments, multimedia packages defined via the centrally-provided interface may be selectively and automatically downloaded to a plurality of network-connected proprietary mobile devices. While large numbers of multimedia mobile devices may be connected to charging devices at various locations around the globe, for example, online multimedia packages may be selectively downloaded (entirely or incrementally) to certain subgroups of these devices, e.g., based on location identifiers, client/user identifiers, tour (or other) group identifiers, and/or device identifiers. In such a manner, for example, a tour operator for a specific geographic location may centrally create and/or define a specific multimedia package (e.g., an audio tour; e.g., with at least an audio portion compressed utilizing a particular compression algorithm such as an MPEG-2 Audio Layer III (“MP3”) audio coding format for digital audio and/or an Opus 1.2 codec as published by the IETF on Jun. 20, 2017) for the specific geographic location (or a sub-location thereof) and automatically disseminate the package to a plurality of connected devices at (or near) the location.

Via the GUI, for example, a tour package may be transmitted and/or broadcast to one or more particular charging units (e.g., housing and/or in communication with a plurality of mobile electronic devices). According to some embodiments, various software, firmware, settings, and/or other data of the mobile electronic devices (e.g., coupled to individual charging bays of a charging unit) may be remotely managed via the GUI. A first version of the tour package may be transmitted to each device of a first subset of the mobile electronic devices, for example, while a second version of the tour package may be transmitted to each device of a second subset of the mobile electronic devices. In some embodiments, a multimedia content package may be provided to a specific charging unit and the charging unit may disseminate the package to each connected mobile device. According to some embodiments, file parameters stored in each mobile device may be compared to parameters for the new or updated content to identify portions of the content that are different than portions already resident on the devices. In such a manner, for example, proportional or incremental updates and/or changes to content stored in the mobile devices may be effectuated. In some embodiments, device settings may be set and/or changed for a plurality of devices at one time. Power usage settings and/or modes (e.g., standby mode), button functions, application restrictions, brightness levels, and/or other settings may be defined by a profile or template, for example, that is pushed down from the server and through the charging unit to a selected subset of mobile devices. It may be desirable, for example, for devices utilized at a particular location (e.g., inside of a church) to be automatically muted and/or have brightness turned down. In some embodiments, the GUI may permit various remote group and/or individual device controls such as individual device scrubbing or formatting, individual device bouncing and/or resetting, and/or global (e.g., for each device coupled to a selected charging unit) device reboot. In some embodiments, a command-line interface such as may utilize an Android Debug Bridge (ADB) command-line interface may be utilized to send commands to individual and/or subsets of selected devices from the server/central location.

According to some embodiments, the plurality of network-connected devices may be charged and/or managed en mass. Large numbers of mobile electronic devices (e.g., twenty (20), fifty (50), or more) may be simultaneously charged and monitored, for example, via one or more network-connected charging stations in communication with the MDM system. According to some embodiments, a charging station may comprise a plurality of circuit boards (e.g., Printed Circuit Board (PCB) devices), each comprising an Integrated Chip (IC) processing unit and a communications and/or power distribution hub (e.g., a Universal Serial bus (USB) hub). In such a manner, for example, multiple charging ports or locations may be resident and/or disposed on each circuit board and may receive communications and/or power managed by the IC for the specific circuit board. Similarly, the IC may manage the acquisition and dissemination of information from each charge location/port. According to some embodiments, each charging device may comprise a communications hub that manages communications (and/or power distribution) to and/or from each of a plurality (e.g., four (4)) of circuit boards. In some embodiments, data descriptive of charge state and/or other device characteristics for each of the connected devices (e.g., multiple devices per circuit board) may be transmitted from the charging station to the MDM. The charging station may relay to the MDM, for example, charge state information, battery health information (e.g., number of charge cycles to-date), firmware version information, loaded software version information, and/or stored analytics metrics (e.g., data descriptive od device usage). In some embodiments, an encrypted and/or terminal services-level link may be established between the charging unit and the server such that even when utilizing restricted networks, secure and consistent communication may be established between the charging unit and the server. Secure Sockets Layer (SSL) and/or Secure SHell (SSH) protocols may be utilized, for example, to allow the charging unit to send a charging unit identifier and other data (e.g., charge data and/or mobile device data) to a pre-coded network address for the server in a real-time manner. According to some embodiments, a distributed state machine architecture may be utilized to reduce bandwidth required for client-server communications.

The data may be analyzed, in some embodiments, and actions taken in response to an application of stored rules to the analyzed data. Charge information for individual devices may be utilized, for example, to set and/or adjust individual device charging rules, schedules, and/or parameters. In the case that a device has a reduced battery storage state, for example, the device charging may be held in abeyance until the specific device is chosen/selected for future use (e.g., in the case the device is selected for downloading of a specific software package and/or version, and/or is identified as a member of a group of devices for use in a group tour). Device usage information may, in some embodiments, be utilized to provide location-specific analytics. A group and/or subset of devices utilized at a specific tourist (and/or other) location may, for example, be analyzed to provide useful metrics such as number of visitors (e.g., number of times the devices have been utilized to effectuate a multimedia tour), number of stops (e.g., tour stop locations that correspond to certain multimedia content), time at each stop (visitors may spend different amounts of time at different stops; total, average, etc.), visitors per stop location (not all visitors may visit each stop; some stops may be skipped; total, average, etc.), visitor tour paths (e.g., waypoints, routes, etc.; e.g., based on device location tracking), etc. According to some embodiments, such as in the case that some of the connected devices have different software, firmware, and/or downloaded multimedia content versions than others, such subgroup may be selected for updating and/or upgrading. In some embodiments, a download transmission may be initiated to the identified subset of devices to bring them up to date and/or to synchronize them with other devices. In some embodiments, a subset of connected devices may be selected based on location and/or device ID data for receipt of a particular version of a multimedia content package (e.g., an English-language video tour of a particular location).

The particular version of a multimedia content package may comprise, for example, content specific to a particular tour (or other) group. According to some embodiments, one or more of the devices may be remotely configured as a tour guide or master device such as by downloading and/or configuration specific software and/or device settings. The tour guide or master device may be assigned a particular identifier, for example, that allow and/or facilitates identification and/or location of the device by other devices assigned to the particular tour group. In some embodiments, each device in a tour group may be assigned a specific identifier such as may include a combination of a unique device identifier and a group identifier. In such a manner, for example, the group of devices may be capable of ad-hoc and/or dynamic pairing and/or communications in the “field” (e.g., at the tour location). One device of the group may be within range and communicate with a second device in the group, for example, with the second device being in range with and communicating with the tour guide or master device. In some embodiments, such as in the case that the first device is not within communication range of the tour guide device, information may be relayed between the tour guide device and the first device by the intermediately-located second device. The second device may, for example, operate as a “repeater”, switch, and/or relay to allow indirect communications between the tour guide device and the first device. In such a manner, for example, ad-hoc or dynamic string or mesh networks of user devices may be developed that allow for greater flexibility of master device-guided tours of a given geographic location.

According to some embodiments, the master group device may comprise a self-powered, short-range communications-enabled storage device such as a SanDisk® Wireless Stick. Such a device may, for example, store multimedia tour content data and/or a PWA and be capable of short-range communications (e.g., via Bluetooth®, Wi-Fi®, NFC, IR, RF, and/or other short-range communications protocols and/or methods) with a user's device. The self-powered master group “dongle” may, in some embodiments, utilize the PWA to push selective audio, video, and/or Augmented Reality (AR) content to a connected user's device. As described herein, for example, the PWA may interrogate the user's device and select a portion of available content based on a setting of the user's device, such as a language setting. According to some embodiments, the self-powered master group “dongle” may (e.g., once the user's device connects to a local wireless network hosted by the self-powered master group “dongle”) identify the user device language setting, automatically select a portion of stored multimedia content based on the applicable language (e.g., select a Spanish-version of an AR tour based on a Spanish language setting of the user's device), and may automatically and/or actively push the portion of the content to the user's device (e.g., over the short-range wireless network hosted by the “dongle”).

### XIII. Rules of Interpretation

Throughout the description herein and unless otherwise specified, the following terms may include and/or encompass the example meanings provided. These terms and illustrative example meanings are provided to clarify the language selected to describe embodiments both in the specification and in the appended claims, and accordingly, are not intended to be generally limiting. While not generally limiting and while not limiting for all described embodiments, in some embodiments, the terms are specifically limited to the example definitions and/or examples provided. Other terms are defined throughout the present description.

Some embodiments described herein are associated with a “user device” or a “network device”. As used herein, the terms “user device” and “network device” may be used interchangeably and may generally refer to any device that can communicate via a network. Examples of user or network devices include a PC, a workstation, a server, a printer, a scanner, a facsimile machine, a copier, a Personal Digital Assistant (PDA), a storage device (e.g., a disk drive), a hub, a router, a switch, and a modem, a video game console, or a wireless phone. User and network devices may comprise one or more communication or network components. As used herein, a “user” may generally refer to any individual and/or entity that operates a user device. Users may comprise, for example, customers, consumers, product underwriters, product distributors, customer service representatives, agents, brokers, etc.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately and/or specially-programmed computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software

A “processor” generally means any one or more microprocessors, CPU devices, computing devices, microcontrollers, digital signal processors, or like devices, as further described herein.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

It will be understood that various modifications can be made to the embodiments of the present disclosure herein without departing from the scope thereof. Therefore, the above description should not be construed as limiting the disclosure, but merely as embodiments thereof. Those skilled in the art will envision other modifications within the scope of the invention as defined by the claims appended hereto.

What is claimed is:

1. An electronically-networked system for multimedia content delivery, comprising:
a remote computer server comprising a plurality of electronic processing devices; and
a digital distribution point device in communication with the remote server via a remote network, the digital distribution point device comprising:
an electronic processing device;
a long-range wireless network communication device in communication with the processing device and selectively in communication with the remote computer server via the remote network;
a short-range wireless network communication device in communication with the processing device; and
a non-transitory electronic data storage device in communication with the electronic processing devices, the non-transitory electronic data storage device storing:
(i) multimedia content data;
(ii) a progressive web application; and
(iii) instructions that when executed by the electronic processing devices, result in:
outputting instructions for connecting to the short-range wireless network communication device;
receiving, in response to the outputting, via the short-range wireless network communication device and from a mobile electronic device of a user, a connection request;
retrieving, from the mobile electronic device of the user and by the short-range wireless network communication device, an indication of a setting of the mobile electronic device of the user;
selecting, based on the setting of the mobile electronic device of the user, a subset of the multimedia content data; and
transmitting, to the mobile electronic device of the user and by the short-range wireless network communication device, the subset of the multimedia content data.

2. The electronically-networked system for multimedia content delivery of claim 1, wherein the instructions, when executed by the electronic processing devices, further result in:
retrieving, by the long-range wireless network communication device and from the remote computer server via the remote network, the multimedia content data.

3. The electronically-networked system for multimedia content delivery of claim 1, wherein the outputting, comprises:
broadcasting, via the short-range wireless network communication device, a signal descriptive of the instructions for connecting to the short-range wireless network communication device.

4. The electronically-networked system for multimedia content delivery of claim 3, wherein the instructions comprise human-readable directions describing steps that a user must undertake to accomplish a connection.

5. The electronically-networked system for multimedia content delivery of claim 1, further comprising:
a display device in communication with the processing device.

6. The electronically-networked system for multimedia content delivery of claim 1, wherein the outputting, comprises:
outputting the instructions for connecting to the short-range wireless network communication device via the display device.

7. The electronically-networked system for multimedia content delivery of claim 1, wherein the instructions, when executed by the electronic processing devices, further result in:
transmitting, to the mobile electronic device of the user and by the short-range wireless network communication device, the progressive web application.

8. The electronically-networked system for multimedia content delivery of claim 1, wherein the setting of the mobile electronic device comprises a language setting.

9. An electronically-networked system for selectively managing arrays of remote mobile devices, comprising:
a charging array, comprising:
a plurality of charging slots;
an electrical charging and communications hub in communication with each of the plurality of charging slots;
a long-range network communication device in communication with a remote network; and
a remote computer server, comprising:
a plurality of electronic processing devices, the remote computer server being in communication with the long-range network communication device of the charging array via the remote network; and
a non-transitory electronic data storage device in communication with the electronic processing devices, the non-transitory electronic data storage device storing:
(i) multimedia content data; and
(ii) instructions that when executed by the electronic processing devices, result in:
receiving, from the charging array, an indication of a plurality of unique tour device identifiers corresponding to a plurality of tour devices docked with the charging array;
identifying, for each docked tour device of the plurality of tour devices, and utilizing the corresponding unique tour device identifier, a value of a device characteristic parameter;
identifying, based on user input, a number of tour devices needed for a particular tour;
selecting, from the plurality of tour devices and based on the values of the device characteristic parameters, a subset of the plurality of tour devices, the subset being equal to the number of tour devices needed for the particular tour; and
transmitting, to each of the tour devices of the subset of the plurality of tour devices, utilizing the corresponding unique tour device identifiers, a first multimedia tour package.

10. The electronically-networked system for selectively managing arrays of remote mobile devices of claim 9, wherein the instructions, when executed by the electronic processing devices, further result in:
identifying, based on the user input, a number of parent tour devices and a number of child tour devices needed for the particular tour;
selecting, based on the number of parent tour devices needed for the particular tour, at least one tour device from the subset of the plurality of tour devices to be a parent tour device;
selecting, based on the number of child tour devices needed for the particular tour, at least one tour device from the subset of the plurality of tour devices to be a child tour device;
transmitting, to the at least one tour device from the subset of the plurality of tour devices selected to be the parent tour device, an indication of a parent tour device identifier; and
transmitting, to the at least one tour device from the subset of the plurality of tour devices selected to be the child tour device, an indication of a child tour device identifier.

11. The electronically-networked system for selectively managing arrays of remote mobile devices of claim 9, wherein the identifying of the values of the device characteristic parameters comprises querying the charging array utilizing the unique tour device identifiers and an identifier of the device characteristic parameter.

12. The electronically-networked system for selectively managing arrays of remote mobile devices of claim 9, wherein the receiving of the indication of the plurality of unique tour device identifiers corresponding to the plurality of tour devices docked with the charging array, further comprises receiving, for each of the unique tour device identifiers a corresponding unique charging slot identifier.

13. The electronically-networked system for selectively managing arrays of remote mobile devices of claim 12, wherein the identifying of the values of the device characteristic parameter is conducted by further utilizing the corresponding unique charging slot identifier.

14. The electronically-networked system for selectively managing arrays of remote mobile devices of claim 9, wherein the device characteristic parameter comprises a charge state, charge status, or charge level.

15. The electronically-networked system for selectively managing arrays of remote mobile devices of claim 9, wherein the device characteristic parameter comprises a device type, a firmware version, or an operating system version.

16. The electronically-networked system for selectively managing arrays of remote mobile devices of claim 9, wherein the device characteristic parameter comprises a data capacity.

17. The electronically-networked system for selectively managing arrays of remote mobile devices of claim 9, wherein the device characteristic parameter comprises a screen size, or a screen resolution.

18. An electronically-networked mesh system for providing dynamic tour group management, comprising:
a group tour parent device comprising a wireless transmitter;
a first group tour child device comprising a processing device, an output device in communication with the processing device, a wireless transceiver device in communication with the processing device, and a non-transitory memory device in communication with the processing device, the non-transitory memory device storing:
(i) a group tour identifier; and
(ii) instructions that when executed by the processing device, result in:
receiving, from the wireless transmitter of the group tour parent device and via the wireless transceiver device, at least one of: (a) a multimedia tour package, (b) real-time audio of a tour guide, and (c) an alert or message;
outputting, via the output device, the at least one of: (a) the multimedia tour package, (b) the real-time audio of the tour guide, and (c) the alert or message; and
broadcasting, via the wireless transceiver device, the group tour identifier and the at least one of: (a) the multimedia tour package, (b) the real-time audio of the tour guide, and (c) the alert or message;
a second group tour child device comprising a processing device, an output device in communication with the processing device, a wireless receiver device in communication with the processing device, and a non-transitory memory device in communication with the processing device, the non-transitory memory device storing:
(i) a group tour identifier; and
(ii) instructions that when executed by the processing device, result in:
receiving, by the wireless receiver device, the group tour identifier from the first group tour child device;
identifying, by the processing device, that the stored group tour identifier matches the group tour identifier from the first group tour child device;
receiving, from the first group tour child device and via the wireless receiver device, the at least one of: (a) the multimedia tour package, (b) the real-time audio of the tour guide, and (c) the alert or message; and
outputting, via the output device, the at least one of: (a) the multimedia tour package, (b) the real-time audio of the tour guide, and (c) the alert or message.
